(19) United States
(12) Patent Application Publication
(10) Pub. No.: US 2013/0302679 A1
(43) Pub. Date: Nov. 14, 2013

(54) RECHARGEABLE BATTERY, FUNCTIONAL POLYMER, AND METHOD FOR SYNTHESIS THEREOF

(71) Applicant: Hiroshi Uemachi, Ishikawa (JP)

(72) Inventor: Hiroshi Uemachi, Ishikawa (JP)

(73) Assignee: POLYTHIONE CO. LTD, Nomi-shi Ishikawa (JP)

(21) Appl. No.: 13/700,962

(22) PCT Filed: Jun. 1, 2011
(86) PCT No.: PCT/JP2011/062631

§ 371 Date: Jul. 22, 2013

(30) Foreign Application Priority Data
Jun. 1, 2010 (JP) 2010-125420

(51) Int. Cl. H01M 4/60

(52) U.S. Cl. CPC H01M 4/602
USPC 429/213; 429/209; 525/452

(57) ABSTRACT

A safer rechargeable battery is offered. More concretely, The secondary battery composed to prevent the overcharge is offered.

The electrolyte salt concentration of an electrolyte solution (solid or liquid) and those absolute quantity is controlled in the rechargeable battery in this execution form by using the anode material including n-dope domain and p-dope domain and in which many electron reactions are possible. In the anode of this rechargeable battery disconnection of lithium ion will take place first with the low potential (potential of n dope) at the time of charge, next, absorption of an anion will take place with as high potential (potential of p dope) as the point. Although the career of the ion current is only a lithium ion in the potential of n dope, in p dope potential, anion current flows through the anode side and lithium ion current flows through the cathode side. Thereby, before overcharge, the electrolytic concentration decreases, the internal resistance goes up, and the overcharge is avoided.

### TECHNICAL FIELD

This invention relates to the synthetic method of a rechargeable battery and a functional polymer.

### BACKGROUND

Recent years the application to various technical areas is expected by using a conductive polymer as an electrochemistry element. For example, It becomes possible to save a weight of a battery and maintain high-energy density by using a conductive polymer as an electrode element, to save a weight of a display etc, and make to large area by using the conductive polymer as an electrochromic element, and to use as a biochemistry sensor by attempting making of the conductive polymer minute.

As such the conductive polymer, polypyrrole, polyaniline, polyacene, polythiophene, etc. are mentioned. Technology using an organosulfur compound which has S—S bond (a disulfide bond) in the main chain as a macromolecule, and is shown by a general formula (R—S—S—R) as an anode material of a battery is indicated (Reference, patent document 1).

However, Because reaction velocity is slow as for the organic sulfur compound listed in patent document 1, you must be going to have high temperatures more than at least 100 degrees Celsius to operate it as a battery. In addition, when the organic sulfur compound becomes an organic thiolate (R—SH), because S—S bond is returned at the time of an electric discharge, the organic thiolate melted to an electrolyte, and a reaction efficiency might deteriorate in an anode.

Then, a synthesis method the organic sulfur polymer that an oxidation-reduction reaction is accomplished even as for a low temperature of the room temperature degree as a starting material with a thiourea derivative appropriately is indicated (Reference, patent document 2). This organic sulfur polymer is characterized by including a unit forming a 1,2,4-dithiazole ring in a polymer at the time of the oxidation.

### PRIOR TECHNICAL LITERATURE

### Patent Document

Patent document1: U.S. Pat. No. 4,833,048
Patent document2:JP-A-2003-26655

### SUMMARY OF THE INVENTION

### Problem to be Solved by the Invention

It is intended to provide a safer rechargeable battery. In addition, it is intended to provide an organic sulfur polymer used for the rechargeable batteries mentioned above and the synthetic method.

### Method for Solving the Problem

A rechargeable battery of this invention have an anode comprised of many electrons reaction possible anode materials including n dope domain and p dope domain, and an electrolyte that a density of movable ion was regulated to a density corresponding to a quantity of material of above anode materials.

Preferably the above anode materials are a functional polymer having a thiobiuret or a 1,2,4-dithiazole ring to aside chain.

The functional polymer of this invention has the thiobiuret or the 1,2,4-dithiazole ring to a side chain.

A synthetic method of this invention includes a protection process to add 4-methoxy benzyl chloride to a compound having a 1 or plural thiourea group in the same molecules, and to combine 4-methoxy benzylic to an above thiourea group and to get MPM compound and a polymerization process which adds and heats at reflux an organic solvent to the obtained above-mentioned MPM compound, and obtains an organic sulfur MPM polymer and a deprotection process of adding and heating at reflux anisole under an acid condition to the obtained above-mentioned organic sulfur MPM polymer, and obtaining an organic sulfur polymer.

### Effect of the Invention

According to this invention, the rechargeable battery with higher safety can be offered. Moreover, according to other sides of this invention, the functional polymer used for the above-mentioned rechargeable battery or its electrode and its efficient production method are offered.

### BRIEF DESCRIPTION OF THE FIGURES

FIG. 1 Polymer

FIG. 2 Reaction formula

FIG. 3 Reaction formula

FIG. 4 Chemical structural formula

FIG. 5 Reaction formula

FIG. 6 Chemical structural formula

FIG. 7 Reaction formula

FIG. 8 Reaction formula

FIG. 9 Chemical structural formula

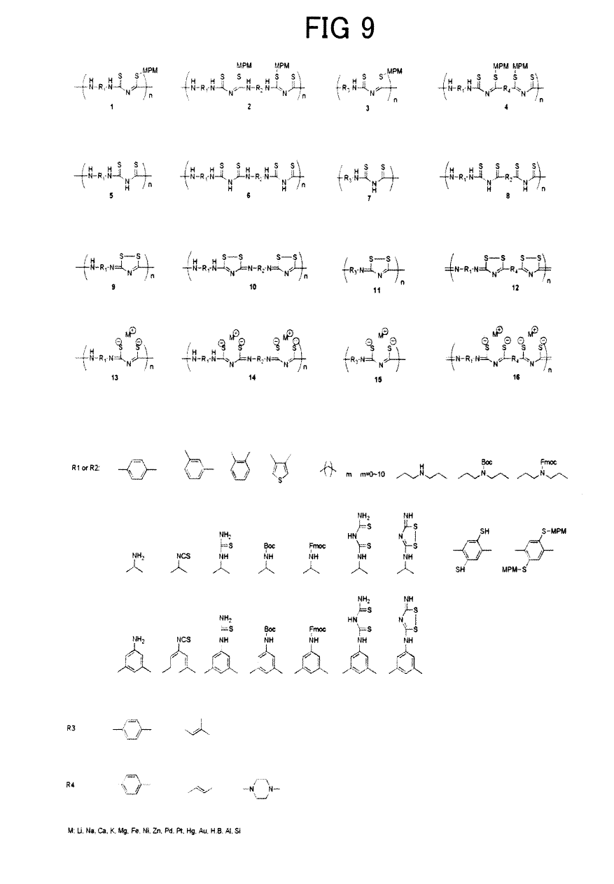

FIG. 10 Chemical structural formula

FIG. 11 Chemical structural formula

FIG. 12 Organosulfur compound and reaction formula

FIG. 13 Reaction formula

FIG. 14 Reaction formula

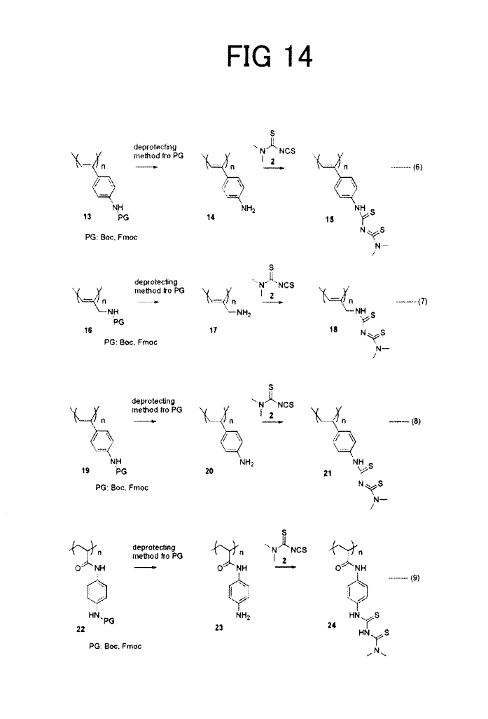

FIG. 15 Reaction formula

FIG. 16 Reaction formula

FIG. 17 Reaction formula

FIG. 18 Reaction formula

FIG. 19 Reaction formula

FIG. 20 reaction formula

FIG. 21 Chemical structural formula

FIG. 22 Reaction formula

FIG. 23 Reaction formula

FIG. 24 Reaction formula

FIG. 25 Reaction formula

FIG. 26 Reaction formula

FIG. 27 Reaction formula

FIG. 28 Reaction formula

FIG. 29 Reaction formula

FIG. 30 Reaction formula

FIG. 31 Reaction formula

FIG. 32 Evaluation list

FIG. 33 NMR spectrum

FIG. 34 Chromatogram result of a measurement

FIG. 35 Chemical structural formula for the evaluation

FIG. 36 Charge-and-discharge graph

FIG. 37 Reaction formula

### DETAILED DESCRIPTION OF THE PREFERRED EMBODIMENTS

The suitable enforcement form of the present invention is explained in detail while referring to an accompanying drawing below. Dimensions, materials, other concrete numerical value to show in the enforcement form to be concerned with are only illustrations to do understanding of the invention if easy and are not a thing limiting this invention particularly unless they mention it. In addition, in this specification and the drawing, duplication explanation is omitted by attaching the same mark about the element which has the same function and composition substantially, moreover, the element which is directly unrelated to the present invention omits illustrations.

[The Background and Outline of a New Functionality Polymerization Thing and its Production Method]

This invention relates to the functional polymer in which an oxidation-reduction reaction is performed reversibly, its production method, the electrode using this functional polymer, the rechargeable electrode using that electrode, etc. Especially this invention has a feature at the point that it is lightweight and a battery of high-energy density is obtained, when it uses for an electrode of a battery.

In recent years, a lithium rechargeable battery using oxidization and reduction of lithium of high electromotive force came to be used as high output and a new style battery of high-energy density. Generally in such a lithium rechargeable battery, metal oxides, such as cobalt, nickel, manganese, iron, vanadium, and niobium, are used as the anode material. However, when such a metal oxide is used for an anode material, because the cost rises dearly if weight of the metal oxide became big, and there were few reaction electron numbers again, and capacity to be able to put in unit weight was not necessarily enough, it was difficult to get a lithium rechargeable battery of the high energy density at high capacity. On the other hand, recently, the conductive polymer is used as an electrochemistry element, it has been examined to use the conductive polymer for electrode material for a battery of a high energetic density and lightness, an electromick element of large area, a biochemistry sensor that used microelectrode. Using an organosulfur compound for the U.S. Pat. No. 4,833,048 specification as an anode material as a polymer which can obtain high capacity and high-energy density is indicated. This is a reversible electrode material of electrolytic reduction cutting S—S combination of an organic disulfide compound, forming organic thiolate, and re-forming an organic disulfide by the electrolytic oxidation of organic thiolate. An organosulfur compound performing charge and discharge using a sulphuric oxidation-reduction reaction, using it for anode material, and obtaining the lithium rechargeable battery of high-energy density is examined. However, for the organosulfur compound, the oxidation-reduction reaction is slow In use under the room temperature, it is difficult to take out a big current alone, the electrical charge and discharge current becomes small, it is an insulator, the rapidity of response is small in use under the room temperature, and there was a problem of the limit to use at the high temperature of 100° C. or more etc. Moreover, since it is a low molecular state at the time of reduction (at the time of electric discharge), out of an electrode, dissolution diffusion is carried out and efficiency degradation of an electrode reaction is brought about. It is indicated to combine the conductive polymer as a method of solving such a problem of the organosulfur compound in JP-A-H4-264363 of specification, JP-A-H4-272659, JP-A-H4-359866, JP-A-H5-6708, JP-A-H5-82133, JP-A-H5-135767, JP-A-H5-135768, JP-A-H5-135769, and U.S. Pat. No. 5,324,599, etc. JP-A-H6-231752 indicates the electrode especially combined to a 4,5diamino-2,6-dimercaptopyrimidine and a π electronic common system conductive polymer among a sulfide system compound, and JP-A-H7-57723 indicates the electrode especially combined to a 7-methyl-2,6,8-trimercaptopurine and a π electronic common system conductive polymer among a sulfide system compound. Moreover, JP-A-H5-74459 indicates the electrode material that has a conductive polymer that has the disulphide group, JP-A-H5-314979 indicates an electrode material that consists of an organic sulfur aroma family system compound that introduces the sulfur atom into the aroma family system carbon atom, JP-A-H6-283175 indicates an electrode material that consists of the copolymer of the homopolymer or both of a 2,5-dimercapto-1,3,4-thiadiazole (DMcT) or the thiocyanuric acid. Furthermore, it is indicated by JP-A-H8-213021, JP-A-H8-222207, JP-A-H9-82329, JP-A-H9-106820, and JP-A-H10-27615 especially about the electrode using a complex with polyaniline which is a conductive polymer which achieves a duty which accelerates an oxidation-reduction speed of an organic disulfide, and It is shown that it is possible to use an organosulfur compound as an electrode material of a rechargeable battery operated at normal temperature by compounding 2,5-dimercapto-1,3,4-thiadiazole (DMcT) and polyaniline. (┌Modernization study┘, October, 1996, Clause 34-clause 41) However, because a compound that accompanies a chemical linkage doesn't newly generate it, a capacity degradation cannot be suppressed to complete in this complex. Moreover, a separation of the polyaniline and the DMcT happens in the electrode, a movement of an electron is obstructed, and electrode reaction speed may fall. In addition, in order to raise a cycling characteristics of an organic disulfide electrode, using the metal complex of an organic disulfide (specification of U.S. Pat. No. 5,516,598, etc., U.S. Pat. No. 5,665,492, JP-A-H 9-259864, JP-A-H9-259865, JP-A-H10-241661, and JP-A-H10-241662) and using an anode constituted by a mixture of conductive polymer and a lithium thiolate compound which have a S—Li ionic bond which generates S—S bond by electrolytic oxidation (JP-A-H5-314964), etc. are known. A high capacity positive pole material fee with a redox active polymer mainly composed of an organic sulfur is proposed by Uemachi etc. as the high capacity battery material in a series of patent including JP-A-H11-248086. Since 5 member rings which have S—S bond within a polymer are formed, charge and discharge are repeatedly possible for this redox active polymerization thing. Moreover, the redox active polymer has a π electron cloud in five member ring that has the S—S bond, In addition, it has the structure where the aromatic compounds or the heterocyclic compound which has the n electron cloud in the both sides of this 5 member ring was combined, an electronic movement is smoothly performed about this functional polymer, when this functionality polymer is used for the battery electrode, a discharge and a charge in a large current becomes possible. It has been reported that the redox active polymer is an anode material which has many merits, such as the above.

In this invention, it is a problem to offer a new functionality polymer that can be suitably used for a battery of a high energetic density and lightweight, a electrochromic device of a large area, and the a biochemistry sensor using a micro electrode, etc, also at a low temperature, an oxidation-reduction reaction in this new functional polymer is performed appropriately, when this functionality polymer is used for a battery electrode, an appropriate electrical charge and discharge reaction is performed in a low temperature, for instance, the room temperature, and In this invention, it is a problem to obtain the battery of a high energetic density and the high capacity in addition to a charge and a discharge in a big current becoming possible.

There are the five issues which should be solved in the high capacity anode material by the redox active polymer reported by JP-A-H11-248986 as a high capacity battery material. The first three problems are caused because it is being offered to the battery reaction with S title of a redox active polymer made a conductor by the protecting group of the alkyl group etc.

The first problem is that initial electric discharge capacity becomes small. In an early battery reaction, disconnection of a protecting group has priority and progresses in the redox active polymer. Since this reaction is low potential more compared with a S—S reaction in electric discharge and a reaction progresses with high potential more in charge, the capacity of an early battery reaction is small and unsuitable as a high capacity battery. The second problem is deterioration in the battery reaction. Since the disconnected protecting group remained in the inside of a battery, that is, the impurities of the low molecule remain in the inside of a battery, if the side reaction by a protecting group arises inside an anode, the battery reaction is obstructed, and there is a possibility of obstructing the reaction of cathode that eluted from the anode, too. Since a protecting group is contained per unit of a polymer as for an equimolar amount, influence also becomes large. The 3rd problem is that it is not desirable from a viewpoint of improvement in capacity. Since a derivative of an equimolar amount is contained in a battery as it is per unit of a polymer, when it calculates to the weight of a protecting group, since the battery capacity of substance decreases, it is desirable to remove the derivative in advance.

The 4th is a problem about a synthetic method. In the method described in JP-A-H11-248086, the synthetic reaction speed is slow. Therefore, the synthesis time becomes long, a large amount of manufacturing becomes difficult, and practical use is difficult.

The last 5th subject is that the flexibility of a synthetic method is scarce, and that the extendibility of a redox active polymer is restricted. Additionally, there is an item directly related to electrical machinery ability of a voltage and an output, etc. though the first function requested for electrode material is an improvement of capacity. Moreover, various and broad demand of reduction of cost, processing of form, compounding, etc. exists for electrode material. A correspondence to these various requests becomes possible by preparing many building blocks, such as departure medicines and middle medicines. The possibilities of material designs of a molecular structure and a polymer three-dimensional structure, etc. are extended by choice of a building block. Moreover, selecting the material corresponding to the cost demand by combining building blocks becomes possible. In the synthesis method claimed by JP-A-H11-248086, the proposal to these demands did not exist, and generality, the extendibility, and the practicality of the redox active polymer were limited.

This inventor newly developed the synthesis method of the polymer reactant which introduced a 1,3-dithioketo and a diamine into a polymer main chain claimed by JP-A-H11-248086 and other patents that relate to it, and succeeded in the solution of five problems explained by the above-mentioned.

The problem 3 from the problem 1 was solved by changing R group that was the protecting group from the benzyl group described in embodiment of JP-A-1111-248086 to MPM and tert-butyl. There are three conditions requested for the protecting group. The first is that S-alkylation reacts easily by derivatizing S in the thiourea part. The 2nd is that a dithiobiuret is easily formed of S-alkyl which derivatized. The 3rd is that advances about 100% by the subsequent disconnection S. A protecting group was selected in consideration of these three points. It has been reported that tert-butyl group introduced as o-ether disconnects easily under an acid condition. It is an electron-donative effect by hyperconjugation of the tert-butyl group. It was assumed to develop this view to the sulfur which is the chalcogen fellows same as oxygen, and it examined it. As a group that electronic structure was near to the tert-butyl, other the tertiary carbon was examined. The MPM protecting group also similarly has an electron-donative, when the MPM protecting group is introduced into O-ether, disconnecting under an acid condition has been reported. When the tert-butyl and the MPM were used as a protecting group as a result of examining the above-mentioned three points, the fact that the S-ether formation, the dithiobiuret formation and the subsequent elimination reaction advanced easily was confirmed to the thiourea part or the thioamide part. In particular, in MPM, the effect is high, it was confirmed that it was effective for the synthesis of the building block that formed the redox active polymer and the redox active polymer. It becomes possible to obtain the redox active polymer from which the protecting group was removed about 100% after chemical synthesis, and three problems of the decrease of early electric discharge capacity, deterioration of a battery reaction, and the decrease of real capacity were able to be solved by using this protecting group.

It succeeded in solving the 4th problem that the rapidity of response of the synthesis is slow, by applying the microwave method and a non-solvent synthetic method to the synthetic conditions of dithiobiuret. In the synthesis of the dithiobiuret part, the micro wave processing is very effective, and the reaction will end in a short time. It is a reaction suitable for the microwave synthesis because the structure of the departure medicine and the structure of the product are big chemical structures of the polarity. Moreover, it was confirmed that the reaction ended in a short time when the non-solvent synthesis is done independently of the micro wave processing. In a non-solvent processing, the synthetic reaction will progress easily in a short time without adding other solvents if the departure medicine is a solution. It is desirable to add very small amount solvent if the departure medicine is a solid. After a small amount of solvent is added, the reaction will progress in a short time by almost removing the solvent once by doing decompression and desiccation, putting into the state of the slurry, and doing the heating reaction. The non-solvent synthesis in this invention includes the synthesis in the state of the slurry that contains very small amount solvent. It is assumed that the frequency of the collision of the departure medicine rises by keeping the departure medicine in a high density state of the slurry, and the reaction is promoted. Though these micro wave synthesis and non-solvent synthesis are effective in the promotion of the synthesis even if it is separate, even if both are used at the same time, it is useful. Moreover, the method of adding the strong base without using the protecting group as another method of solving the problem from 1 to 4 was invented. In composition of the dithiobiuret (—NH(C═S)NH(C═S)NH—) part, the same effect as 1 to 4 is brought by adding a specific strong base, the method of obtaining functionality polymer to have the dithiobiuret part that is target structure and building blocks such as the departure medicines and the middle medicines was established. In order to solve the 5th subject, the new synthesis method that building blocks, such as the start medicines and the middle medicines, can be supplied is developed, and many new building blocks were synthesized by the synthesis method. The flexibility, the extendibility, and the practicality of the redox active polymer became higher by this new synthesis method and the new building block. It became easy to solve the problem 5 by the synthesis approach developed for the solution from the problem 1 to 4. The adjustment of an efficient building block became possible by applying the introduction and the elimination of the MPM protecting group, the microwave method and the non-solvent synthesis method.

[Background and Outline of Rechargeable Battery that Improves Safety]

The electrolyte salt concentration of an electrolyte solution (solid or liquid) and those absolute quantity is controlled in the rechargeable battery in this execution form by using the anode material including n-dope domain and p-dope domain and in which many electron reactions are possible. As a result, it becomes a secondary battery to which the battery safety circuit is constructed with the material level.

Here, the n dope is the state that materials in itself is tinged with a negative charge. In other words, n dope is in the state where a cation (lithium ion etc.) goes in and out as counterion of charge compensation. In addition, since a battery reaction mechanism is considered with the usual inorganic material as a state which took in lithium ion (=Reduction state), the material except lithium ion itself can be called n dope state which is tinged with a minus electric charge.

Moreover, the p dope is the state that materials in itself is tinged with a positive charge. In other words, the p dope is in the state where an anion (PF⁶⁻, Cl⁻, Clo⁴⁻, and BF⁴⁻ etc.) goes in and out as counterion of charge compensation. In addition, since a battery reaction mechanism is considered with the usual inorganic material as a state which took in lithium ion (=Reduction state), in the state where a fixed quantity of lithium cations were emitted (=De-dope), a charge reaction is ended, the anion does not participate in battery reaction itself.

In the case of the conventional lithium battery, lithium ion is mainly bearing the ion current inside a battery, and all battery capacity is decided by quantity possessed of lithium ion. The lithium ion in the battery dissolves to the electrolyte along with the battery reaction, moves the inside of the battery as a lithium ion, and is absorbed by the other partner pole. The concentration of the lithium ion of the electrolyte solution doesn't change in a stage all the battery reactions and the value of the current of the ion reaches the same value almost. On the other hand, since the rechargeable battery of this enforcement form shares the amount of accumulation of electricity with the lithium cation and the anion, the career of ion current is not only lithium ion, and it is different according to the stage of the battery reaction. The current carrier of the ion has the stage only of the lithium ion and the stage of the lithium ion and the anion. If a phenomenon is surveyed focusing on an anode, disconnection of lithium ion will take place first with the low potential (potential of n dope) at the time of charge, next, absorption of an anion will take place with as high potential (potential of p dope) as the point. As for a negative pole, the lithium ion is absorbed in all stages. Although the career of the ionization current is only a lithium ion in the potential of n dope, in p dope potential, anion current flows through the anode side and lithium ion current flows through the cathode side.

Internal resistance goes up before overcharge and overcharge is avoided by the above-mentioned principle. The overcharge is charging a battery exceeding the specified final voltage. In the usual lithium battery, with overcharge, the surplus lithium ion (the lithium ion that should not take part in reaction) discharge and elution of the metal ions, such as an oxide, the lithium dendrite generation, and the solvent resolution take place from the anode side, and it causes thermal run-away. Therefore, when the overcharge by material is controlled, the battery reaction at the overcharge early stage can be restrained or control. In a word, it is important to design the battery to end the battery reaction in the domain of stored electrical quantity of the schedule. It only has to decrease the electrochemical reaction inside the battery in this area, namely, just to decrease the ionization current inside the battery. It is the point that the control methods of this ion current differ by the conventional battery and the present invention. In the case of the conventional lithium battery, lithium ion is mainly bearing the ion current inside a battery, and all battery capacity is decided by quantity possessed of lithium ion. The lithium ion in the battery dissolves to the electrolyte along with the battery reaction, moves the inside of the battery as a lithium ion, and is absorbed by the other partner pole. The concentration of the lithium ion of the electrolyte solution doesn't change in a stage all the battery reactions and the value of the current of the ion reaches the same value almost. On the other hand, since this invention form shares the amount of accumulation of electricity with the lithium cation and the anion, the career of ion current is not only lithium ion, and it is different according to the stage of the battery reaction. The current carrier of the ion has the stage only of the lithium ion and the stage of the lithium ion and the anion. If a phenomenon is surveyed focusing on an anode, disconnection of lithium ion will take place first with the low potential (potential of n dope) at the time of charge, next, absorption of an anion will take place with as high potential (potential of p dope) as the point. As for a negative pole, the lithium ion is absorbed in all stages. Although the career of the ionization current is only a lithium ion in the potential of n dope, in p dope potential, anion current flows through the anode side and lithium ion current flows through the cathode side. This is considered from the electrolytic concentration. Like the lithium battery usual in the potential of p⁻ dope, the electrolytic concentration is constant and the ion current value is also almost constant. Since both ion is absorbed by the pole material and electrolytic concentration decreases in the potential of n⁻ dope, the value of the current of the ion becomes small, and the internal resistance rises. Thus, the change (that is, the decrease of value of current of ion or the rise of internal resistance) in the domain of the potential of the n⁻ dope in the charging status that became a high capacity in the electrolytic concentration is used for the battery reaction control. The resistance inside the battery is enlarged (When the electrolyte salt concentration of battery solution decreases, ion conductance decreases and the internal resistance becomes large.) in the stage that becomes the upper bound (near the maximum in which ion absorption is possible at the time of assuming the time of charge) of the quantity (the amount of accumulation of electricity) possessed of the lithium ion and an overcharge (or the amount of charge set up in advance), and it leads to the stop upper bound voltage. The function of the current interruption valve in the material level to end the battery reaction compulsorily is made to reveal by choosing a suitable optimal condition.

Moreover, in the overcharge, it is generation of the dendrite of the lithium metal in the cathode side surface to become a problem. The dendrite inside the battery is short-circuited in the pole interval, and there is a possibility of causing the ignition etc. In this invention, the dendrite control when electricity is overdischarged is also possible. In the conventional lithium battery, all capacity was secured with the quantity possessed of lithium ion. Then, the amount of accumulation of electricity of the electric charge was adjusted with the lithium ion quantity possessed of an anode and cathode both sides. In principle, the lithium ion quantity possessed of an anode and cathode both sides is an equivalent amount. (In practice, although lithium ion quantity possessed of the cathode is made more, it does not usually become the trouble of the argument on the present invention.) Therefore, in an anode, lithium ion will almost be disconnected itself, and in a cathode (In a lithium ion battery, it is usually the host material of a carbon system.), lithium ion will be in the state near saturation at the end of charge. Since lithium ion is accumulated in the surface instead of the inside of cathode material by the turbulence of a battery reaction, etc., a possibility that it will become a lithium metal and a dendrite will generate increases.

On the other hand, it is since lithium ion and an anion share the amount of accumulation of electricity in the anode material in the present invention, the dangerous dendrite generating can be controlled. The lithium ion quantity possessed of the two poles of an anode and a cathode is not theoretically equivalent. The lithium ion quantity possessed by the side of a cathode increases only more than a part for the amount of anion reactions by the side of an anode. Here, the amount of accumulation of electricity of an anode and a cathode is controlled for safety reservation. The buffer area of the dendrite generation evasion on the surface can be secured for the inside of a cathode by securing an empty site of the lithium ion among the numbers of reaction sites that can be the accumulation of electricity on the side of a cathode.

It explains the enforcement form of this invention as follows.

The rechargeable battery of this enforcement form consists of an anode which consisted of an anode material including n dope domain and p dope domain, and in which many electron reactions are possible, and a cathode containing cathode materials, such as metallic lithium, and an electrolyte adjusted to the concentration corresponding to the amount of substance of anode material.

### Lithium Battery Reaction

The compound shown in 5 from 1 adjusted with the synthetic method in the embodiment described later is chosen as an anode active material (an anode material), the lithium battery was made by the following methods, and the battery characteristic was evaluated. The capacity of the anode active material was assumed the completion when discharge and charge reaction was made to react about two electrons per two atom of sulfur for each unit and led.

### 1) Creation of an Anode Element

Lithium battery anode medical mixture powder 1 g was adjusted by carrying out pulverization mixture of anode active material, acetylene black, and the PVDF on a mortar by bulk density 45/45/10. NMP was suitably added to this powder as a dilution solvent, and the anode mixture ink to applying was adjusted. The addition of NMP ended when the anode mixture ink became like the slurry. The anode mixture ink like the slurry was applied to the aluminum foil of 20 μm in thickness with the coater braid. After carrying out preliminary drying under room temperature for after-application 24 hours, 60° C. and 5-hour dry processing were performed with the vacuum dryer, and the anode sheet was created. After carrying out 70° C. heat press processing after dryness, it is pierced by the circle of 10φ, the anode element was created. After performing 60° C. and 2-hour drying by heating processing to this anode element with a vacuum dryer again, it was quickly moved to the glove box and the lithium battery was created continuously.

### 2) Creation of a Lithium Battery

The glove box is carrying out the flow of the dry air of 70° C. of dew point, the lithium battery was assembled under this dry atmosphere. The created anode element is used for an anode, and 1M-LiPF6-EC-DMC was used for the electrolyte solution. The metallic lithium pierced by 12φ is used for a negative pole, and the cell guard pierced by 14φ was used for the separator. The coin type cell of 2032 types is prepared as an exterior material of the battery, and it occupies it with an exclusive rivet machine that set it up in the glove box after assembling the material, and the coin type cell for the examination was made. The electrolyte solution of 400 μl had measured by micropipette, It was injected into the coin type battery after the element was incorporated. A density of the electrolytic salt of the electrolyte solution has been adjusted to 1M-LiPF6-EC-DMC, 0.5M-LiPF6-EC-DMC, 0.1M-LiPF6-EC-DMC, 0.05M-LiPF6-EC-DMC, and 0.01M-LiPF6-EC-DME.

### 3) Battery Evaluation

After performing the discharge and charge reaction in the constant current in the reaction of two electrons per unit (equivalent to using only n dope reaction) 5 times using the lithium battery created by 2), the charge and discharge reaction in the constant current in the reaction of four electrons per unit (equivalent to using n dope reaction and p dope reaction) was performed 5 times. As a result, it was assumed that the amount of the electrolyte, the concentration of the electrolyte, and the potential reaction control were simply confirmed. If first n-dope reactions of five times are possible and subsequent n-dope reactions and p-dope reactions of five times are impossible or unstable by the examination battery of the same lot, the experiment on the principle of this invention was able to be verified. As a result, in the case of the electrolytic concentration of 1M-LiPF6-EC-DMC and 0.5M-LiPF6-EC-DMC the potential reaction up to 10 times was possible. Although the battery reaction of the all capacitive components of four electrons is not repeated 5 to 10 times, the battery reaction of the capacitive component equivalent to p-dope reaction has been confirmed. On the other hand, in 0.1M-LiPF6-EC-DMC, although the battery reaction up to 5 times was possible, the 6th time and afterwards, the battery reaction for p-dope reaction did not occur, it resulted in the rise of battery voltage at the time of charge, and resulted in descent of battery voltage at the time of electric discharge. (It thinks because it was not able to charge.)

The combination of the anode material in which p-dope reaction and n-dope reaction are possible, the electrolyte salt concentration of an electrolyte solution, and the battery charge and discharge reaction conditions showed that control of battery reaction was possible. As mentioned above, it has evaluated that construction of the battery constructing technique in which battery safety circuit construction on a material level is possible was possible by controlling the electrolyte salt concentration and those absolute quantity of an electrolyte solution using the anode material including n-dope domain and p-dope domain and in which many electron reactions are possible.

Next, the example of the functional polymer used for the rechargeable battery of the above-mentioned enforcement form, etc. as an anode active material is explained. In addition, the use of the functional polymer explained below is not limited to the above-mentioned rechargeable battery.

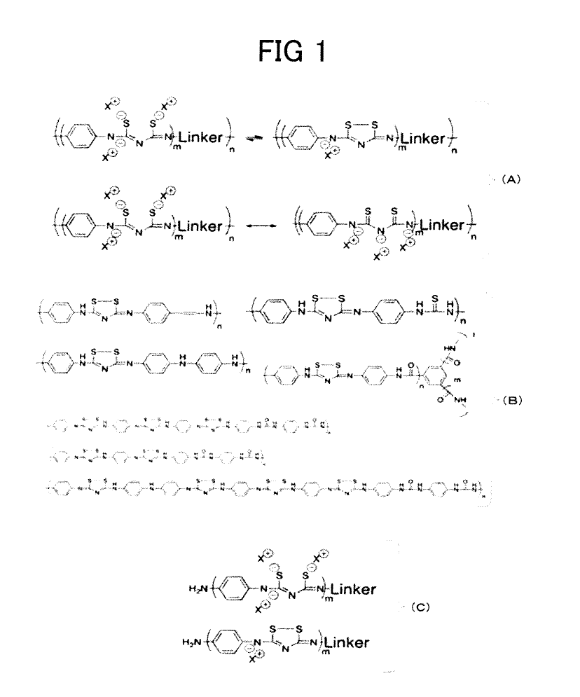

The functional polymer of this enforcement form is a polymer illustrated to FIG. 1 (A). The general notations X is a monovalent cation, such as H⁺, Li⁺ or K⁺, or a cation more than bivalence, such as Ca²⁺ or Mg²⁺, and The general notations n are two or more polymers, preferably 50 or more polymers.

The general notations m are one or more polymers, preferably four or more polymers, and the linker section is connected by metallic elements other than alkyl, allyl, aryl and hydrocarbon. Moreover, functional groups, such as amide, ester, ether, urea, thioamide, thioether, and thiourea may combine with each of both ends of the above-mentioned linker section. The polymer exists in a reduction state or a oxidation state or in the state where a reduction state and an oxidation state are intermingled. As for the polymer, the above-mentioned state may be mixed.

Moreover, the polymer illustrated to FIG. 1 (B) may be sufficient as a functional polymer. The general notations X of the building block (SS ring composition) which constitutes a polymer are a monovalent cation, such as H⁺, Li⁺ or K⁺, or a cation more than bivalence, such as Ca²⁺ or Mg²⁺, and the general notations n are two or more polymers, preferably 50 or more polymers, and the general notations m are one or more polymers, preferably four or more polymers.

The Linker section is connected by metallic elements other than alkyl, allyl, aryl and hydrocarbon. Moreover, functional groups, such as amide, ester, ether, urea, thioamide, thioether, and thiourea may combine with each of both ends of the above-mentioned linker section. The polymer exists in a reduction state or a oxidation state or in the state where a reduction state and an oxidation state are intermingled. As for the polymer, the above-mentioned state may be mixed.

Moreover, the functional polymer may be the polymer illustrated to FIG. 1 (C). The general notations X of the building block (SS ring composition) which constitutes a polymer are a monovalent cation, such as H⁺, Li⁺ or K⁺, or a cation more than bivalence, such as Ca²⁺ or Mg²⁺, and the general notations n are two or more polymers, preferably 50 or more polymers, and the general notations m are one or more polymers, preferably four or more polymers.

The Linker section is connected by metallic elements other than alkyl, allyl, aryl and hydrocarbon. Moreover, functional groups, such as amide, ester, ether, urea, thioamide, thioether, and thiourea may combine with each of both ends of the above-mentioned linker section. The polymer exists in a reduction state or a oxidation state or in the state where a reduction state and an oxidation state are intermingled. As for the polymer, the above-mentioned state may be mixed.

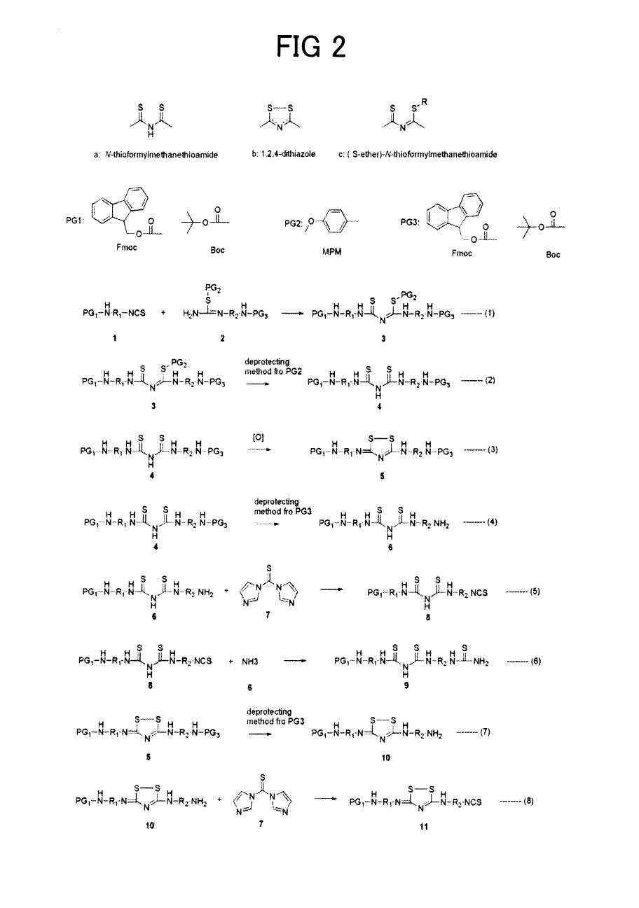

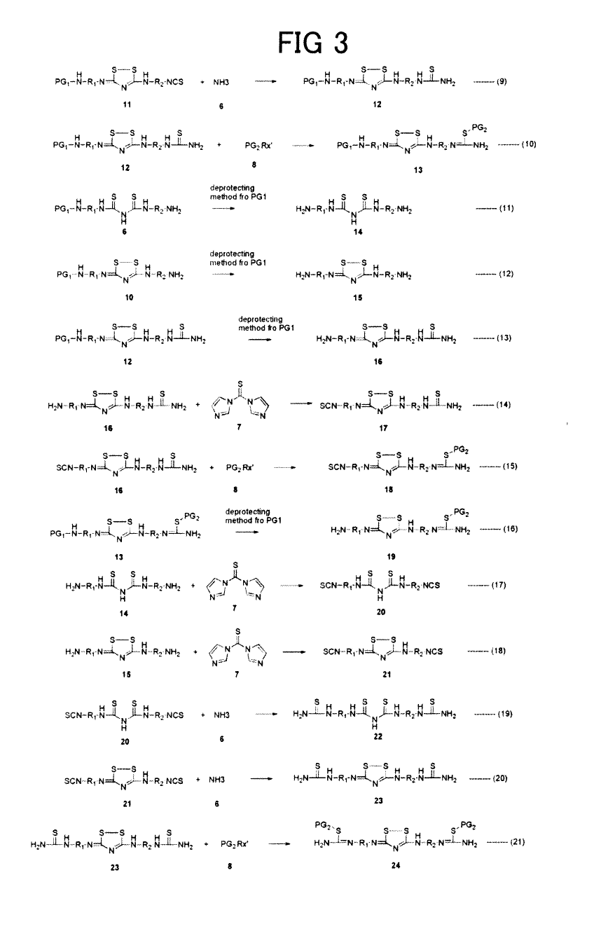

Moreover, as illustrated in FIG. 2 and FIG. 3, Building block that composes polymer (SS ring composition). The invention thing expressed as 3, 4, 5, 6, 8, 9, 11, 12, 13, 14, 15, 16, 17, 18, 19, 20, 21, 22, and 23 used as the intermediary compound (building block) which can form the polymer which has oxidation-reduction reaction activity and has the chemical structure a, b, or c which can serve as functional materials which can be used for electrode material etc. The formulas (1), (2), (3), (4), (5), (6), (7), (8), (9), (10), (11), (12), (13), (14), (15), (16), (17), (18), (19), (20), and (22) which are the production methods of these invention things. The protecting group of amine is used for PG1 and PG3 of a chemical constitution formula. Preferably, Fmoc or Boc is used for PG1 and PG3. The protecting group of oxygen or sulfur is used for PG2, and, preferably MPM is used. Alkyl or its derivative, allyl or its derivative, or aryl or its derivative is used for R1, R2, and R3.

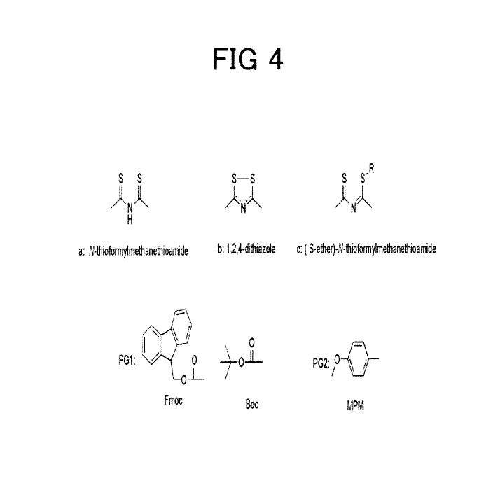

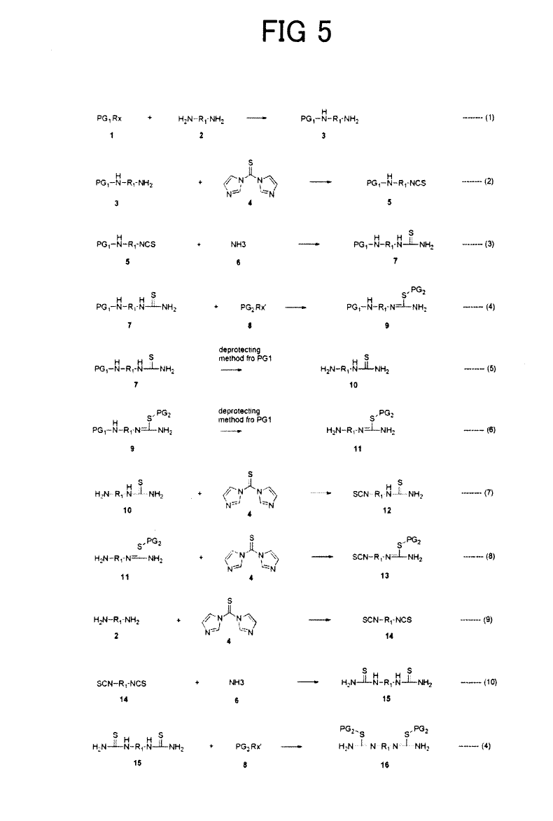

Moreover, as illustrated in FIG. 4 and FIG. 5, Building block (A, B) start thing that composes polymer. The invention thing expressed as 3, 4, 5, 6, 8, 9, 11, 12, 13, 14, 15, and 16 used as the intermediary compound (building block) which can form the polymer which has oxidation-reduction reaction activity and has the chemical structure a, b, or c which can serve as functional materials which can be used for electrode material etc. The formulas (1), (2), (3), (4), (5), (6), (7), (8), (9), and (10) which are the production methods of these invention things. The protecting group of amine is used for PG1 of a chemical constitution formula. Preferably, Fmoc or Boc is used. The protecting group of oxygen or sulfur is used for PG2, and, preferably MPM is used. Alkyl or its derivative, allyl or its derivative, or aryl or its derivative is used for R1, R2, and R3.

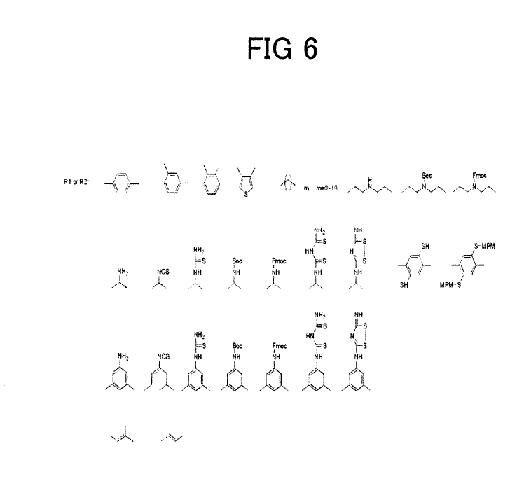

In addition, R1 and R2 mentioned above, may be the building block comprised of a structural formula to exemplify in FIG. 6.

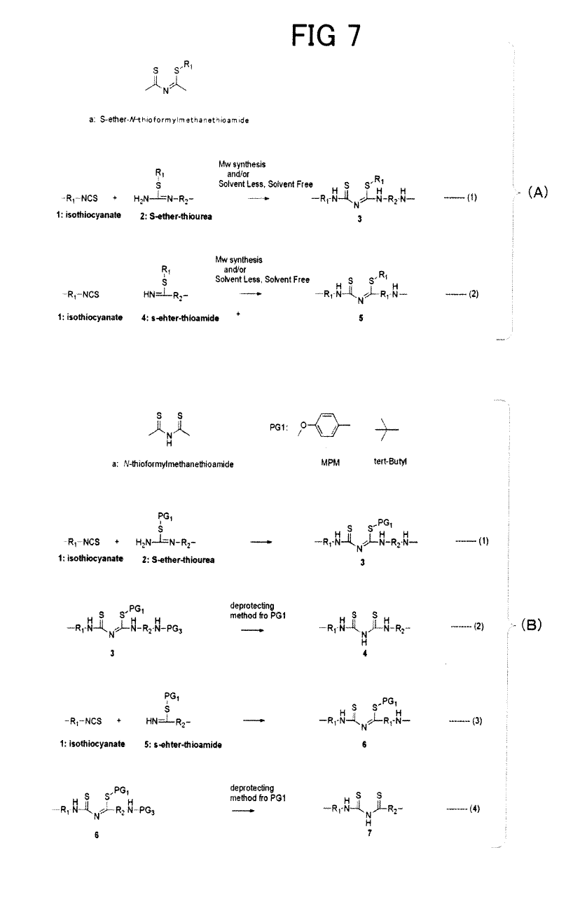

Moreover, it illustrates to FIG. 7 (A), In order to promote the addition reaction of S-ether-thiourea group 2, or S-ether-thioamide 4 and isothiocyane group 1, to shorten the reaction time which forms S-alkyl-N-thioformylmethanethioamid group 3,5 and to raise yield, S-alkyl-N-thioformylmethanthioamide is manufactured by using the microwave composition or/and the non-solvent composition method.

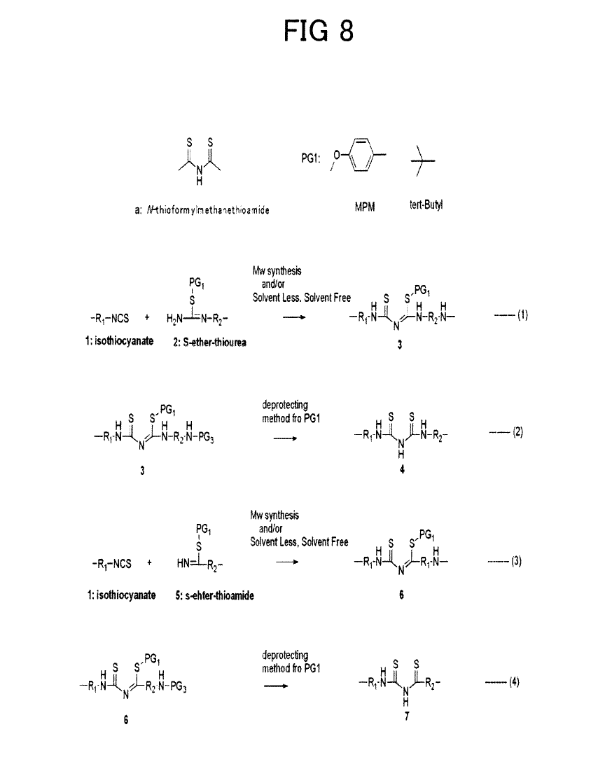

Moreover, as illustrated in FIG. 8, the addition reaction of a s-ether-thiourea group 2 or s-ether-thioamide group 5 which improved the reaction activity by having made it etherify in advance by PG1 (MPM or tert-butyl) of a specific protecting group and an isothiocyane 1 is made to be quickly advanced using microwave synthesis or/and non-solvent synthesis, afterwards, a N-thioformylmethanethioamide 4,7 is formed and obtained by carrying out the disconnection reaction of the protecting group concerned, it may be a method of manufacture of a N-thioformylmethanethioamide that uses a specific protection concerned radical to which reactive activation and making to the disconnection easily progress.

The product described in the following chemical formula which has a MPM group as the precursor.

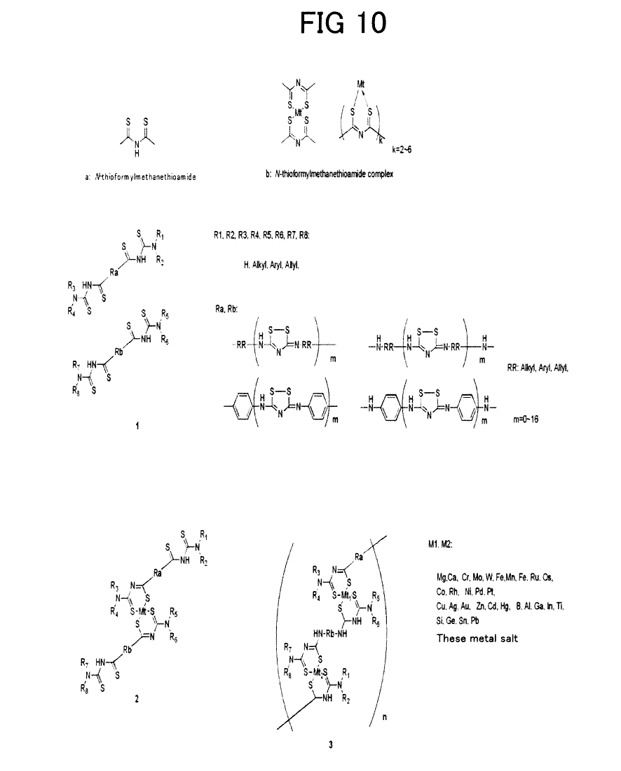

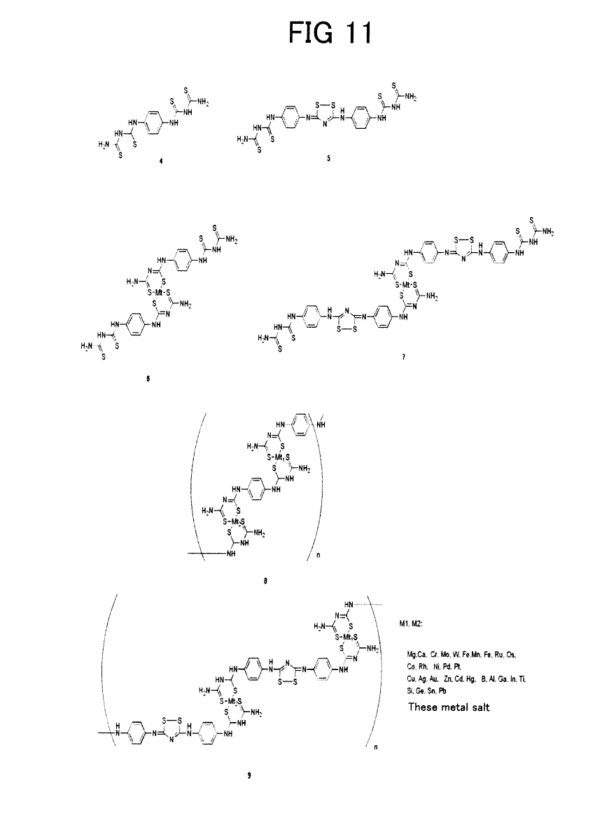

Moreover, as illustrated in FIG. 10 and FIG. 11, The production method which forms the complex structure b because N-thioformylmethane thioamide groups a of two or more configurates to a central metal ion from the ligand part 1 which has N-thioformylmethane thioamide groups a of two or more, and Mt that is metal ion more than two values, and obtains supermolecule structure 3,8,9 of possible oxidation-reduction reaction. 1,4,5, Forerunner structure 2,6,7 that is ligand that becomes the component. Ra and Rb of the oxidation-reduction activator 1 which has two or more N-thioformylmethanethioamide group a in one molecule consists of a repetition structures of having the 1,2,4-dithiazole ring, the repetition structure connects and consists of alkyl, aryl, and allyl. R1, R2, R3, and R4 of amine of the end of the ligand structure 1 expresses hydrogen, alkyl, aryl, or allyl. The metal ion Mt, Mt1, and Mt2 consists of Mg, Ca, Cr, Mo, W, Fe, Mn, Fe, Ru, Os, Co, Rh, Ni, Pd, Pt, Cu, Ag, Au, Zn, Cd, Hg, B, Al. Ga, In, Ti, Si, Ge, Sn, Pb or these metal salt.

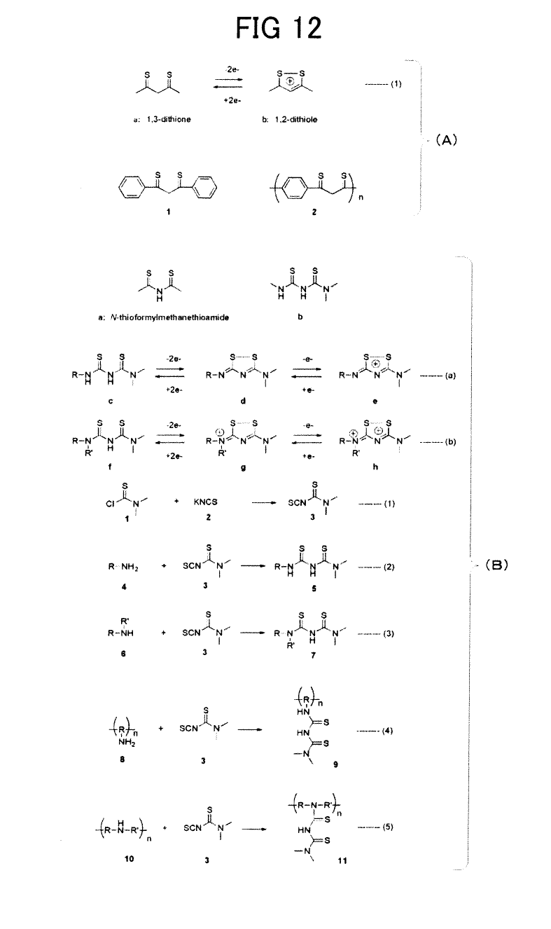

As illustrated in FIG. 12(A), The electrode medical mixture which are the structures with a main organosulfur compound I or 2 which has in a molecule a which is a structure part which can be stored electricity by structural change of 1,3-dithione group a and 1,2-dithiole group b by the oxidation-reduction reaction shown in an expression (1).

As illustrated in FIG. 12(B),

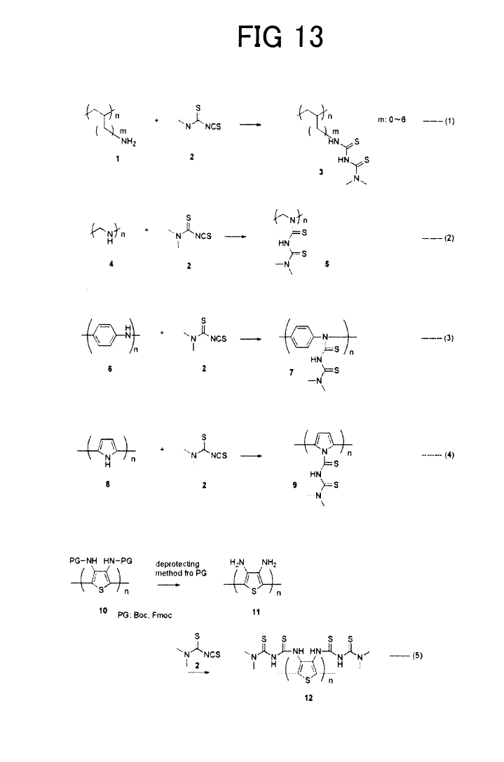

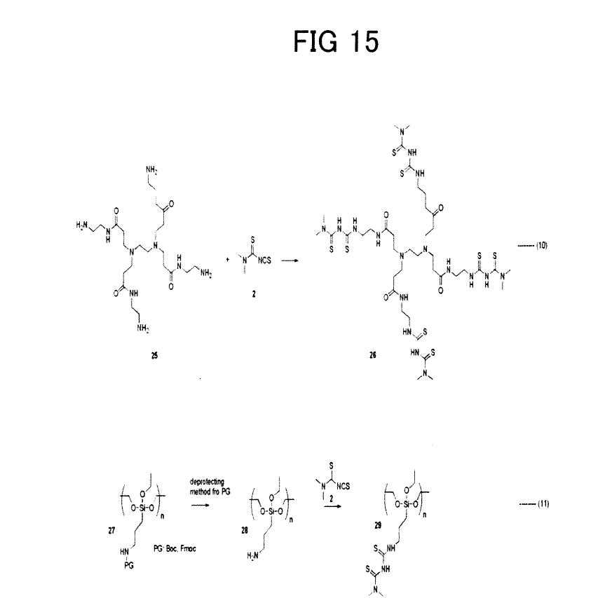

As illustrated in FIG. 13, FIG. 13, and FIG. 15, The functional polymer and the production method in which an oxidation-reduction reaction given in the structural formula of this figure obtained by the production method of the above-mentioned statement is possible. The production method (1) which introduce N-thioformylmethanethioamide group into a polyamine side chain by post-processing and thioformylmethanethioamide derivatization polyamine 3. The production method (2) which introduce N-thioformylmethanethioamide group into a polyimine side chain by post-processing and thioformylmethanethioamide derivatization polyimine 5. The production method (3) which introduce N-thioformylmethanethioamide group into a polyaniline side chain by post-processing and thioformylmethanethioamide derivatization polyaniline 7. The production method (4) which introduce N-thioformylmethanethioamide group into a polypyrrole side chain by post-processing and thioformylmethanethioamide derivatization polypyrrole 9. The production method (5) which introduce N-thioformylmethanethioamide group into a polythiophene side chain by post-processing and thioformylmethanethioamide derivatization polythiophene 12. The production method (5) and (7) which introduce N-thioformylmethanethioamide group into a polyacetylene side chain by post-processing and thioformylmethanethioamide derivatization polyacetylene 15 and 18. The production method (3), (4), (5), (6), and (7) which introduce N-thioformylmethanethioamide group into an electroconductive polymer side chain by post-processing and thioformylmethanethioamide derivatization electroconductive polymer 7, 9, 12, 15, and 18. The production method (8) which introduce N-thioformylmethanethioamide group into a polystyrene side chain by post-processing and thioformylmethanethioamide derivatization polystyrene 21. The production method (9) which introduce N-thioformylmethanethioamide group into a polyacrylamide side chain by post-processing and thioformylmethanethioamide derivatization polyacrylamide 24. The production method (10) which introduce N-thioformylmethanethioamide group into a dendrimer side chain by post-processing and thioformylmethanethioamide derivatization dendrimer 26. The production method (11) which introduce N-thioformylmethanethioamide group into a siloxane polymer side chain by post-processing and thioformylmethanethioamide derivatization siloxane polymer 29.

Moreover, the electrode element whose electrode reaction active thing of the above-mentioned statement is a major component. Furthermore, batteries, such as a lithium metal battery, a lithium ion battery, a magnesium battery, a calcium battery, a proton battery, and a radical battery which used this electrode element for the electrode. Furthermore, the lithium battery which uses this electrode element for an anode and in which a cathode consists of lithium system cathode elements, such as a lithium metal, a graphite carbon system material, and lithium alloy.

Embodiment 1, embodiment 2, and embodiment 3 are explanations of the synthetic method of the functional polymer of having the dithiobiuret (—NH(C═S)NH(C═S)NH—), the S-protecting group introduction dithiobiuret (—N═H(C—S-PG1)NH(C═S)NH—, PG: a protecting group), and the 1,2,4-dithiazole ring, and are explanations of obtaining the functional polymer of having the dithiobiuret and 1,2,4-dithiazole ring newly by these chemical treatments. There was a description in a past embodiment only when the functional polymer to have the dithiobiuret and 1,2,4-dithiazole ring were obtained because of the electrolysis processing after it built it in the electrode element, moreover, the method by the chemical treatment was not specified in a past embodiment. Embodiment 1 and embodiment 2 are explanations of the synthetic method and the composition to obtain the functional polymer to have the dithiobiuret and 1,2,4-dithiazole ring newly by the chemical treatment that makes disconnection of the S-protecting group easy. Embodiment 3 is an example of the method of obtaining building blocks such as the functional polymer, the departure medicines, and the middle medicines that have the dithiobiuret part it becomes easy to synthesize the dithiobiuret part by adding a specific strong base.

### Embodiment 1

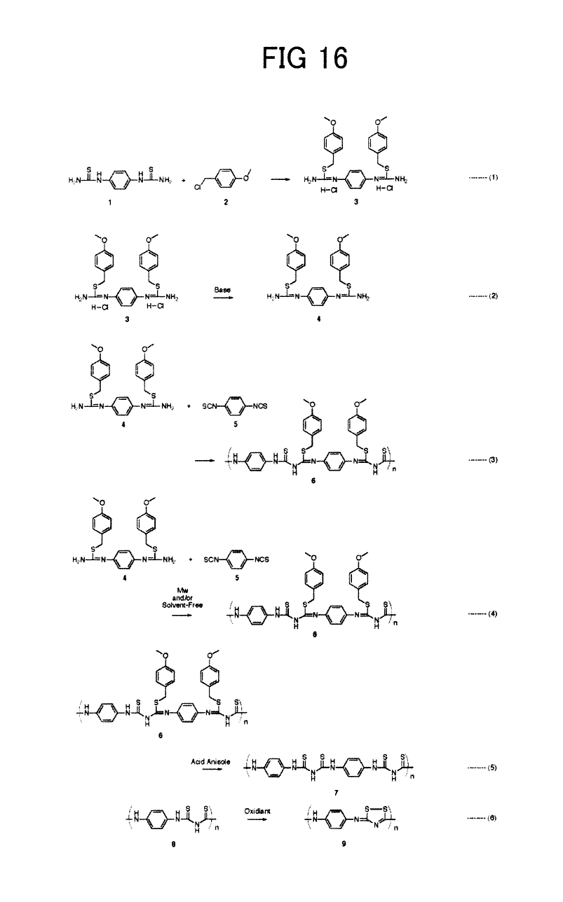

It explains the method of obtaining the functional polymer to have the dithiobiuret and 1,2,4-dithiazole ring newly by the chemical treatment whose S-protecting group is disconnect easily referring to FIG. 16 where the AB type reaction with two departure medicine molecules of A molecule+molecule of B is shown.

### 1) Synthesis of (4-Isothiocyanato-phenyl)-(S-MPM) Thiourea Hydrochloride

(4-thioureido-phenyl)-thiourea 1 (1.8 g, 8 mmol), 4-methoxybenzyl chloride 2 (2.75 g, 1.7.6 mmol), and DMF 10 ml were added to the recovery flask of 50 ml, and 80° C. heating reaction was done for three hours. Ethyl acetate 50 ml was added after the cold of a reactive liquid was discharged at the room temperature, and it stirred it at the room temperature for 30 minutes. Then, suction filtration was carried out and the powder of the cream on the funnel was collected. The suck filtration was done after this powder was distributed to ethyl acetate 100 ml, and it stirred it at two hour room temperature and a funnel cream-colored powder was collected. Thus, the (3.9 g, 7.2 mmol) (S-MPM) thiourea hydrochloride 3 of the objective was obtained. (FIG. 16 expression (1))

### 2) Adjustment of (S-MPM) Thiourea

Thiourea hydrochloride 3 (2.7 g, 5 mmol) and NaHCO₃ (1.7 g, Double volume of thiourea) were added to Erlenmeyer flask of 500 ml filled with the mixture solution of water 100 ml-ethyl acetate 100 ml-THF 50 ml solution. This solution is stirred at the room temperature for 30 minutes, and the organic layer was separated after that using the separatory funnel. Separating and extraction of this organic layer are again carried out with a saturated salt solution, and the dehydration processing was done adding anhydrous MgSO₄ after collecting the organic layers. Afterwards, the solution that removed MgSO₄ by filtration was moved to the recovery flask, and decompression and desiccation was done with evaporator. The yellow target solid (S-MPM) thiourea 4 (1.97 g, 4.2 mmol) was able to be obtained in the recovery flask by evaporator which set hot-water bath temperature as room temperature. (FIG. 16 expression (2))

Synthesis of Polymer a (Solution Reaction)

Heating at reflux was performed for the solution which distributed (S-MPM) thiourea 4 (0.47 g, 1 mmol) and 1,4-phenylene diisocyanate (0.19 g, 1 mmol) 5 with chloroform 30 ml in a recovery flask of 100 ml for 72 hours. After the reaction had ended, after the cold of a reactive liquid was discharged at the room temperature, diethylether 50 ml was poured, and the polymer that had dissolved was detected. The sludge that adhered to the wall of the flask was scratched and taken in the spatula, and the target polymer was collected. This salvaged material is thrown into ethanol 30 ml, after stirring at the room temperature for 30 minutes, and repeating work of filtration three times, similarly, this salvaged material is thrown into acetone 30 ml, after stirring at the room temperature for 30 minutes, and repeating work of filtration three times, 60° C. vacuum drying was done for one hour, and a target (S-MPM) polymer 6 of 0.52 g was obtained. (FIG. 16 expression (3))

Synthesis of Polymer b (Non-Solvent Reaction)

(S-MPM) thiourea 4 (0.47 g, 1 mmol) and 1,4-phenylene diisocyanate were added to the recovery flask of 50 ml, chloroform 10 ml was added in addition, the return current tube was installed, and the heating reaction was performed for 10 minutes at 80° C. The color of the solution has changed from a pale yellow transparent solution into a yellow-green transparent solution at once. A reaction is once stopped in 10 minutes, after the cold of a reactive liquid was discharged up to the room temperature, chloroform was removed by evaporator. Contents of the flask after the solution had been removed were translucent-yellow-sticky material. After changing into the state of a non-solvent mostly, again, the return current tube was installed in the recovery flask, and the heating reaction was performed for one hour at 80° C. A transparent-orange dendrite material of the orange color generated it in the bottom of the recovery flask after the reaction had ended. The product of the bottom of the recovery flask was crushed with the spatula, and collected. This salvaged material is thrown into ethanol 30 ml, after stirring at the room temperature for 30 minutes, and repeating work of filtration three times, similarly, this salvaged material is thrown into acetone 30 ml, after stirring at the room temperature for 30 minutes, and repeating work of filtration three times, 60° C. vacuum drying was done for one hour, and a target (S-MPM) polymer 6 of 0.47 g was obtained. (FIG. 16 expression (4))

### Synthesis of Polymer c (Microwave Reaction)

The microwave reaction was done by using Discover made by the SEM company. The glass tube (10-ml sealing vial with exclusive septum) for Discover also in a glass container was used. (S-MPM) thiourea 4 (0.23 g, 0.5 mmol) and 1,4-phenylene diisocyanate 5 (0.19 g, 0.5 mmol) were added to a 10-ml sealing vial, and further, after adding chloroform 5 ml, It sealed it with the silicon septum lid. This sealing up vial was set up in Discover made by the SEM company by a predetermined method, the microwave reaction was executed while performing magnet stir at 70° C. in preset temperature and 10 minutes in reactive time. After the reaction ended, after chloroform in the sealing up vial was decompressing removed, diethylether of 8 ml was poured, the sludge that adhered to the wall and the tube bottom was scratched and taken with the spatula, and the target polymer was collected. This salvaged material is thrown into ethanol 30 ml, after stirring at the room temperature for 30 minutes, and repeating work of filtration three times, similarly, this salvaged material is thrown into acetone 30 ml, after stirring at the room temperature for 30 minutes, and repeating work of filtration three times, 60° C. vacuum drying was done for one hour, and a target (S-MPM) polymer 6 of 0.23 g was obtained. (FIG. 16 expression (4))

### Removal of Protecting Group (MPM)

(S-MPM) polymer 6 (0.6 g, 1.82 mmol) and 4M-HCL dioxane of an acidic organ solvent was added to the recovery flask of 100 ml, the stir was done at the room temperature for ten minutes. Subsequently, after adding anisole (0.4 g, 3.7 mmol) and stirring at the room temperature for a while, reflux stirring was carried out and the heating reaction was performed for 1.5 hours. After the reaction ended, the reactive solution that discharged cold up to room temperature was poured into NaHCO₃ 4 g/H₂O 100 ml+THF 100 ml+ether 50 ml, and the sludge was collected. Thus, the polymer 7 0.3 g which is a final object which disconnected the protecting group (MPM) was obtained. (FIG. 16 expression (5)) Although the polymer 7 is obtained in the state of reduction, it is also possible to obtain the oxidant polymer in which S—S bond is made to perform by chemical conversion coating with the oxidant. (FIG. 16 expression (5))

### Embodiment 2

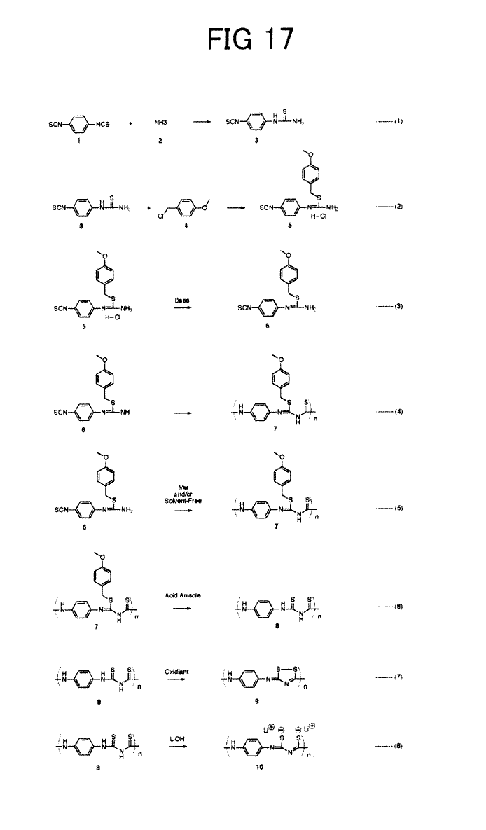

It explains the method of obtaining the functional polymer to have the dithiobiuret and the 1,2,4-dithiazole ring newly by the chemical treatment whose S-protecting group is disconnect easily referring to FIG. 17 where the AB type reaction with one departure medicine molecules is shown.

### 1) Synthesis of (4-Isothiocyanate-Phenyl)-Thiourea

A 1,4-phenylene diisothiocyanate (5 g, 26 mmol) and THF 200 ml are added to the three-pronged flask of 500 ml, and reactive solution A has been adjusted. A Dropping funnel was set up in the side tube of this flask. The dropping funnel was filled with reactive solution B that diluted the NH₃ solution 1.8 g with THF 100 ml and adjusted it. Solution B was dropped while stirring solution A under the room temperature, and it reacted under the room temperature. The reaction was then continued at room temperature for 12 hours. A reactive solution was sucking filtered, and a white powder was collected. A Distributed solution that added a white powder to hexane 200 ml for the purpose of washing removal of impurities was adjusted, and it stirred at room temperature for five hours Afterwards, this distributed solution was sucking filtered, a white powder on the funnel was collected, and (4-Isothiocyanate-phenyl)-thiourea 3 (4.2 g, 20 mmol) of the objective was obtained. (FIG. 17 expression (1))

### 2) Synthesis of (4-Isothiocyanato-Phenyl)-(S-MPM) Thiourea Hydrochloride

(4-Isothiocyanato-phenyl)-thiourea 3 of 2.4 g (11.5 mmol), 4-methoxybenzyl chloride of 2 g (12.8 mmol), and THF of 20 ml are added to a flask of 50 ml, reflux stirring was carried out and the heating reaction was performed for 3 hours. After the cold of the reactive solution was discharged at the room temperature, added acetone 50 ml and stirred at the room temperature for 30 minutes. Then, suction filtration was carried out and the powder of the cream on the funnel was collected. The suck filtration was done after this powder was distributed to acetone 100 ml, and it stirred it at two hour room temperature and a funnel cream-colored powder was collected. Thus, the (3.64 g, 9.95 mmol) (4-Isothiocyanato-phenyl)-(S-MPM) thiourea hydrochloride 5 of the objective was obtained. (FIG. 17 expression (2))

### 3) Adjustment of (4-Isothiocyanato-Phenyl)-(S-MPM) Thiourea

(4-Isothiocyanato-phenyl)-(S-MPM) thiourea hydrochloride 5 (1.85 g, 5 mmol) and NaHCO₃ (1.7 g, Double volume of thiourea) were added to the three-pronged flask of 500 ml filled with the mixture solution of water 100 ml-ethyl acetate 100 ml-THF 50 ml solution. This solution is stirred at the room temperature for 30 minutes, and the organic layer was separated after that using the separatory funnel. Separating and extraction of this organic layer are again carried out with a saturated salt solution, and the dehydration processing was done adding anhydrous MgSO₄ after collecting the organic layers. Afterwards, the solution that removed MgSO₄ by filtration was moved to the recovery flask, and decompression and desiccation was done with evaporator. The yellow target solid (S-MPM) thiourea 6 (1.43 g, 4.4 mmol) was able to be obtained in the recovery flask by evaporator which set hot-water bath temperature as room temperature. (FIG. 17 expression (3))

### 4) Synthesis of Polymer a (Solution Reaction)

Heating at reflux was performed for the solution which dissolved (4-Isothiocyanato-phenyl)-(S-MPM) thiourea 6 (1.65 g, 5 mmol) with chloroform 30 ml in a recovery flask of 100 ml for 72 hours. After the reaction had ended, after the cold of a reactive liquid was discharged at the room temperature, diethylether 50 ml was poured, and the polymer that had dissolved was detected. The sludge that adhered to the wall of the flask was scratched and taken in the spatula, and the target polymer was collected. This salvaged material is thrown into ethanol 30 ml, after stirring at the room temperature for 30 minutes, and repeating work of filtration three times, similarly, this salvaged material is thrown into acetone 30 ml, after stirring at the room temperature for 30 minutes, and repeating work of filtration three times, 60° C. vacuum drying was done for one hour, and a target (S-MPM) polymer 7 1.1 g was obtained. (FIG. 17 expression (4))

### 5) Synthesis of Polymer b (Non-Solvent Reaction)

(4-Isothiocyanato-phenyl)-(S-MPM) thiourea 6 (0.6 g, 1.8 mmol) was added to the recovery flask of 50 ml, chloroform 10 ml was added in addition, the return current tube was installed, and the heating reaction was performed for 10 minutes at 80° C. A reaction is once stopped in 10 minutes, after the cold of a reactive liquid was discharged up to the room temperature, chloroform was removed by evaporator. Contents of the flask after the solution had been removed were translucent-yellow-sticky material. After changing into the state of a non-solvent mostly, again, the return current tube was installed in the recovery flask, and the heating reaction was performed for four hours at 80° C. A transparent-orange dendrite material of the orange color generated it in the bottom of the recovery flask after the reaction had ended. The product of the bottom of the recovery flask was crushed with the spatula, and collected. This salvaged material is thrown into ethanol 30 ml, after stirring at the room temperature for 30 minutes, and repeating work of filtration three times, similarly, this salvaged material is thrown into acetone 30 ml, after stirring at the room temperature for 30 minutes, and repeating work of filtration three times, 60° C. vacuum drying was done for one hour, and a target (S-MPM) polymer 7 0.37 g was obtained. (FIG. 17 expression (5))

### 6) Synthesis of Polymer c (Microwave Reaction)

The microwave reaction was done by using Discover made by the SEM company. The glass tube (10-ml sealing vial with exclusive septum) for Discover also in a glass container was used. (4-Isothiocyanato-phenyl)-(S-MPM) thiourea 6 (0.2 g, 0.6 mmol) was added to a 10-ml sealing vial, and further, after adding chloroform of 5 ml, It sealed it with the silicon septum lid. This sealing up vial was set up in Discover made by the SEM company by a predetermined method, the microwave reaction was executed while performing magnet stir at 70° C. in preset temperature and 10 minutes in reactive time. After the reaction ended, after chloroform in the sealing up vial was decompressing removed, diethylether of 8 ml was poured, the sludge that adhered to the wall and the tube bottom was scratched and taken with the spatula, and the target polymer was collected. This salvaged material is thrown into ethanol of 30 ml, after stirring at the room temperature for 30 minutes, and repeating work of filtration three times, similarly, this salvaged material is thrown into acetone of 30 ml, after stirring at the room temperature for 30 minutes, and repeating work of filtration three times, 60° C. vacuum drying was done for one hour, and a target (S-MPM) polymer 7 of 0.12 g was obtained. (FIG. 17 expression (5))

### 7) Removal of Protecting Group (MPM)

(S-MPM) polymer 7 (0.6 g, 1.82 mmol) and 4M-HCL dioxane of an acidic organ solvent was added to the recovery flask of 100 ml, the stir was done at the room temperature for ten minutes. Subsequently, after adding anisole (0.4 g, 3.7 mmol) and stirring at the room temperature for a while, reflux stirring was carried out and the heating reaction was performed for 1.5 hours. After the reaction ended, the reactive solution that discharged cold up to room temperature was poured into NaHCO₃ 4 g/H₂O 100 ml+THF 100 ml+ether 50 ml, and the sludge was collected. Thus, the polymer 8 0.33 g which is a final object which disconnected the protecting group (MPM) was obtained. (FIG. 17 expression (6)) Although the polymer 8 is obtained in the state of reduction, it is also possible to obtain the oxidant polymer in which S—S bond is made to perform by chemical conversion coating with the oxidant. (FIG. 17 expression (7)) Furthermore, the polymerization thing 8 can also be considered as lithium salt polymer by lithiorized processing by lithium hydroxide etc.

### Embodiment 3

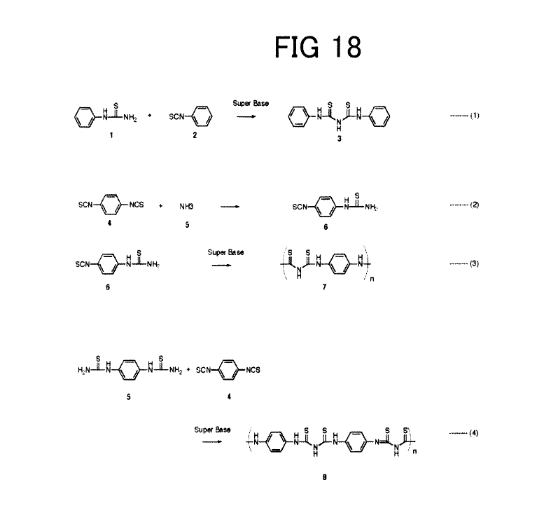

It becomes easy to synthesize the dithiobiuret part by a specific strong base addition, and it explains the method by which building blocks such as the functional polymer, the departure medicines, and the middle medicines that have the dithiobiuret part can be facilitated referring to FIG. 18.

### 1) Synthesis of Diphenyle-Dithiobiuret

The experiment on the synthesis of diphenyle-dithiobiuret was carried out as a model reaction to which the dithiobiuret part was able to be synthesized easily by a strong base addition. NMP of 2 ml, phenylene-thiobiurea (2 mmol) 1, phenylene isothiocyanate (2 mmol) 2, and also DBU (2 mmol) as the strong base were added to a 10-ml glass tube, they are stirred at the room temperature, and a reactive solution has been adjusted. The microwave heating reaction processing was performed to this flask for ten minutes at 80° C. with a microwave synthesis device (made by the CEM). After the heating half was ended, Ethanol acid solution of 1M-HCL was quietly poured into this reactive solution, the stir was done at the room temperature for 30 minutes. Afterwards, this solution was sucking filtered, a yellow powder on the funnel was collected, and N,N′-DiphenylDithiobiuret 3 (3.5 mmol) of the objective was obtained. (FIG. 18 expression (1))

Synthesis of Ditiobiuret Polymer from One Departure Medicine Molecule

According to the prescription of the synthesis of (4-Isothiocyanato-phenyl)-thiourea of embodiment 2, (4-Isothiocyanato-phenyl)-thiourea 6 of the object was adjusted from 1,4-phenylene diisothiocyanate 4 and NH₃ solution. (FIG. 18 expression (2)) NMP of 2 ml, (4-Isothiocyanato-phenyl)-thiourea 6 (2 mmol) 1, and also DBU (2 mmol) as the strong base were added to a 10-ml glass tube, they are stirred at the room temperature, and a reactive solution has been adjusted. The microwave heating reaction processing was performed to this flask for ten minutes at 80° C. with a microwave synthesis device (made by the CEM). After the heating half was ended, Ethanol acid solution of 1M-HCL was quietly poured into this reactive solution, the stir was done at the room temperature for 30 minutes. Afterwards, it washed with the ethanol and THF after this solution had been sucking filtered, a yellow powder was collected, and (N-thioformylthioformamide-phenylendiamine copolymer) 7 of the objective was obtained by the yield of 75%. (FIG. 18 expression (3))

3) Synthesis of Ditiobiuret Polymer from Two Departure Medicine Molecules

NMP of 2 ml, (4-Thioureido-phenyl)-thiourea 6 (1 mmol), 1,4-phenylene diisocyanate 4 (1 mmol), and also DBU (2 mmol) as the strong base were added to a 10-ml glass tube, they are stirred at the room temperature, and a reactive solution has been adjusted. The microwave heating reaction processing was performed to this flask for ten minutes at 80° C. with a microwave synthesis device (made by the CEM). After the heating half was ended, Ethanol acid solution of 1M-HCL was quietly poured into this reactive solution, the stir was done at the room temperature for 30 minutes. Afterwards, it washed with the ethanol and THF after this solution had been sucking filtered, a yellow powder was collected, and (N-thioformylthioformamide-phenylendiamine copolymer) 7 of the objective was obtained by the yield 70%. (FIG. 18 expression (4))

In addition, although DBU was used as a strong base, other amide system strong bases and phosphazene system bases can also be used as a nonionic strong base. Moreover, though KOH, NaOH, ter-AmOK, ter-AMOLi, and KF solid base etc. can be used as an ion strong base, because they are low generally yield, and processing after a reaction also becomes complex as for an inorganic solid, those use is not a suitable method. The following methods including the reaction method of the description to this embodiment is a reaction method with more suitable. Although microwave heating was applied to the heating reaction in this embodiment, a usual heating reaction using an oil bath etc. is also applicable. However, the method using reaction apparatus with sufficient heating efficiency, such as microwave heating and a micro reactor reaction makes the reaction time and the reaction efficiency effective, and becomes this synthetic reaction with desirable processing.

Furthermore, the method uses biphasic responses, such as a reversed micelle reaction, and makes effective the reaction time and the reaction efficiency of the reaction conditions which serve as a synthetic high-concentration reaction system on a micro level and becomes this synthetic reaction with desirable processing. The following solvents including the solvent described to this embodiment are more desirable conditions. In addition to NMP used in this case of the operation, ethers and amid system of the convex polarity solvents such as DMAc, DMF, and THF become desirable solvents. Moreover, although the amount of solvents is used comparatively less in this embodiment, the solvent condition in solvent-free synthesis or minimum amount solvent based on it makes reaction time and yield effective. Although the polymer is obtained in the state of reduction, it is also possible to obtain the oxidant polymer in which S—S bond is made to perform by chemical conversion coating with the oxidant. Furthermore, the polymer can also be considered as lithium salt polymer by lithiorized processing by lithium hydroxide etc.

Embodiment 4, embodiment 5, embodiment 6, and embodiment 7 show the embodiment concerning the building block. Embodiment 4 and embodiment 5 describe the example of synthesizing the building block. Embodiment 4 explains the precursor building block that can form the dithiobiuret or the 1,2,4-dithiazole ring. Embodiment 5 explains the dithiobiuret or the 1,2,4-dithiazole ring building block synthesis. Embodiment 6, embodiment 7, and embodiment 8 describes the example of synthesizing the polymer that uses the building block.

### Embodiment 4

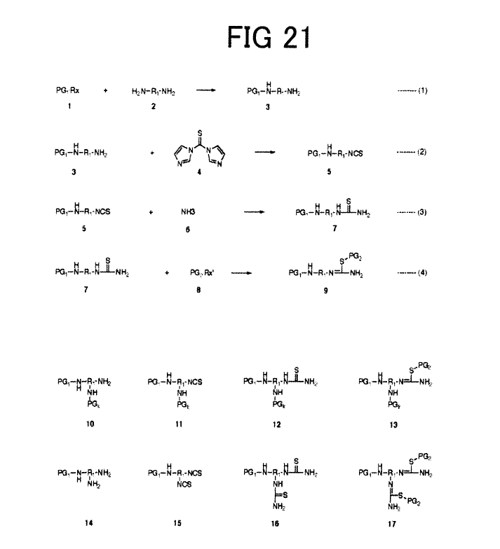

In embodiment 4, the synthetic example of an amine building block (precursor compound that has a protecting group introduction amine and an amine group), an isothiocyanic building block (precursor compound that has a protecting group introduction amine and an isothiocyanic group), a thiourea building block (precursor compound that has a protecting group introduction amine and a thiourea group), and a S-protecting group introduction thiourea building block (precursor compound that has a protecting group introduction amine and a S-protecting group introduction thiourea group). It explains the concept and extendibility of the synthesis of the amine building block, the isothiocyanic building block, the thiourea building block and the S-protecting group introduction thiourea building by using FIG. 21 at the end of embodiment 4.

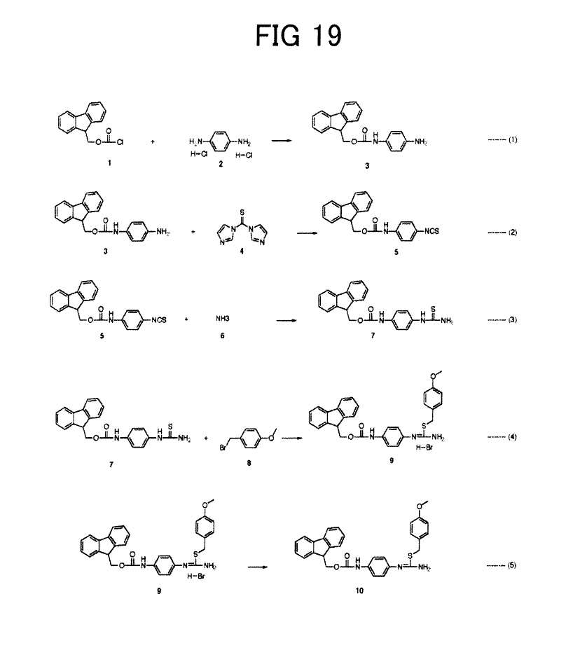

It explains the example of synthesizing the amine building block, the isothiocyanic building block, the thiourea building block and the S-protecting group introduction thiourea building that the amine was protected by Fmoc that is the protecting group referring to FIG. 19.

### 1) Synthesis of Fmoc Building Block

1-1) Synthesis of N-Fmoc P-Phenylene Diamine that is Amine Building Block

P-phenylene diamine hydrochloride2 (0.45 g, 2.5 mmol) and sodium hydrogencarbonate of 0.35 g are dissolved to the mixture solvent of water of 100 ml and dioxane of 100 ml, reactive solution A has been adjusted to a three-pronged flask of 500 ml. A Dropping funnel was set up in the side tube of this flask. The dropping funnel was filled with reactive solution B that dissolved Fmoc-CL 1 (0.65 g, 2.5 mmol) to dioxane of 100 ml and adjusted it. The Solution B was dropped while stirring the solution A under the room temperature, and it reacted under the room temperature. The reaction was then continued at room temperature for 2 hours. After extracting of the reaction solution and dehydrating an organic layer and evaporating of the reaction solution, the separation refinement was performed by the flash chromatography, and N-Fmoc p-phenylene diamine 3 of 0.68 g (2 mmol) that is amine building block of the object was obtained. (FIG. 19 expression (1))

1-2) Synthesis of N-Fmoc-Phenylene Isothiocyanate that is Isothiocyanic Building Block

N-fmoc p-phenylene diamine 3 (1.32 g, 4 mmol) and 1,1′-thiocarbonyldiimidazole 4 (0.88 g, 4.9 mmol) were dissolved THF of 200 ml, and a synthetic reaction was performed under the room temperature for 1 hour. After extracting of the reaction solution and dehydrating an organic layer and evaporating of the reaction solution, the separation refinement was performed by the flash chromatography, and N-Fmoc-phenylene isothiocyanate 5 of 1.2 g (3.2 mmol) that is isothiocyanic building block of the object was obtained. (FIG. 19 expression (2))

1-3) Synthesis of N-Fmoc-Phenylene Thiourea that is Thiourea Building Block

N-Fmoc-phenylene isothiocyanate 5 (1.85 g, 5 mmol) and THF 200 ml are added to a three-pronged flask of 500 ml, and reactive solution A has been adjusted. A Dropping funnel was set up in the side tube of this flask. The dropping funnel was filled with reactive solution B that diluted the NH₃ solution 2 of 1.2 g with THF of 100 ml and adjusted it. Solution B was dropped while stirring the solution A under the room temperature, and it reacted under the room temperature. The reaction was then continued at the room temperature for 12 hours. When the reaction ended, a white powder extracted it to the flask bottom. the reactive solution was sucking filtered, and the white powder was collected. A Distributed solution that added the white powder to hexane of 200 ml for the purpose of washing removal of impurities was adjusted, N-Fmoc-phenylene thiourea 7 (1.4 g, 3.6 mmol) that is thiourea building block was synthesized. (FIG. 19 expression (3))

1-4) Synthesis of N-Fmoc-Phenylene (S-MPM) Thiourea Bromate that is S-Protecting Group Introduction Thiourea Building Block

N-Fmoc-phenylene thiourea 7 (2 g, 5 mol), 4-methoxybenzyl blomide 2 (1.5 g, 7.5 mmol), and DMF of 2 ml are added to the recovery flask of 50 ml, and a reactive solution A has been adjusted. The Return current stirring of the reactive solution A was performed and the heating reaction was performed for 3 hours. After the cold of the reactive solution was discharged at the room temperature, added ethyl acetate of 50 ml and stirred at the room temperature for 30 minutes. Then, suction filtration was carried out and a powder of the cream on the funnel was collected. The suck filtration was done after this powder was distributed to ethyl acetate of 100 ml, and it stirred it at the room temperature for 2 hours and a funnel cream-colored powder was collected. Thus, the N-Fmoc-phenylene (S-MPM) thiourea bromate 9 (1.9 g, 3.2 mmol) that is S-protecting group introduction thiourea building block of the objective was obtained. (FIG. 19 expression (4))

1-5) Adjustment of N-Fmoc-Phenylene (S-MPM) Thiourea that is S-Protecting Group Introduction Thiourea Building Block

N-Fmoc-phenylene (S-MPM) thiourea bromate 9 (2.1 g, 3.5 mmol) and NaHCO₃ (0.6 g, 2 times the amount of thiourea) were added to erlenmeyer flask of 500 ml filled with the mixture solution of water of 100 ml-ethyl acetate of 100 ml-THF solution of 50 ml. This solution is stirred at the room temperature for 30 minutes, and the organic layer was separated after that using the separatory funnel. Separating and extraction of this organic layer are again carried out with a saturated salt solution, and the dehydration processing was done adding anhydrous MgSO₄ after collecting the organic layers. Afterwards, the solution that removed MgSO₄ by filtration was moved to the recovery flask, and decompression and desiccation was done with evaporator. N-Fmoc-phenylene (S-MPM) thiourea 10 (1.43 g, 2.8 mmol) that is S-protecting group introduction thiourea building block of the objective was obtained in the recovery flask by evaporator which set hot-water bath temperature as room temperature. (FIG. 19 expression (5))

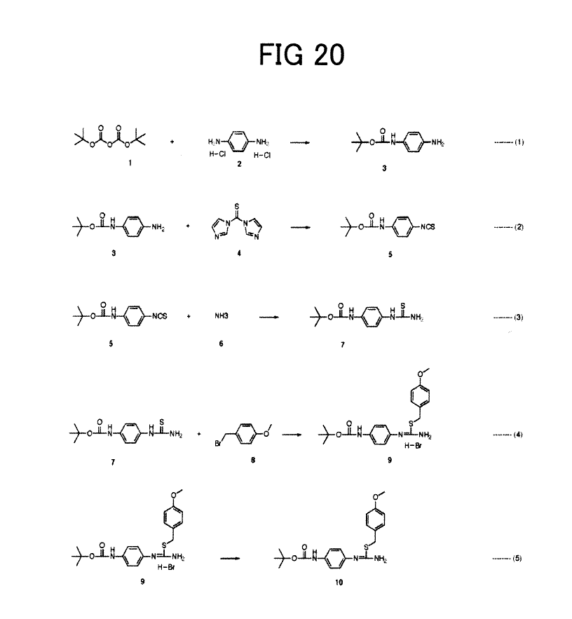

It explains the example of synthesizing the amine building block, the isothiocyanic building block, the thiourea building block and the S-protecting group introduction thiourea building that the amine was protected by Boc that is the protecting group referring to FIG. 20.

### 2) Synthesis of Boc Building Block

2-1) Synthesis of N-Boc P-Phenylene Diamine that is Amine Building Block

P-phenylene diamine hydrochloride2 (0.45 g, 2.5 mmol) and Sodium hydrogencarbonate of 0.35 g are dissolved to the mixture solvent of water of 100 ml and dioxane of 100 ml, Reactive solution A has been adjusted to a three-pronged flask of 500 ml. A Dropping funnel was set up in the side tube of this flask. The dropping funnel was filled with reactive solution B that dissolved di-t-butyl dicarbonate 1 (0.55 g, 2.5 mmol) to dioxane of 100 ml and adjusted it. The Solution B was dropped while stirring the solution A under the room temperature, and it reacted under the room temperature. The reaction was then continued at room temperature for 2 hours. After extracting of the reaction solution and dehydrating an organic layer and evaporating of the reaction solution, the separation refinement was performed by the flash chromatography, and N-Boc p-phenylene diamine 3 of 0.42 g (2 mmol) that is amine building block of the object was obtained. (FIG. 20 expression (1))

2-2) Synthesis of N-Boc-Phenylene Isothiocyanate that is Isothiocyanic Building Block

N-Boc p-phenylene diamine 3 (0.89, 4 mmol) and 1,1′-thiocarbonyldiimidazole 4 (0.88 g, 4.9 mmol) were dissolved THF of 200 ml, and the synthetic reaction was performed under room temperature for 1 hour. After extracting and drying and evaporating of the reaction solution, the separation refinement was performed by the flash chromatography, and N-Boc-phenylene isothiocyanate 5 that is Isothiocyanic building block of 0.8 g (3.2 mmol) was obtained. (FIG. 20 expression (2))

2-3) Synthesis of N-Boc-Phenylene Thiourea that is Thiourea Building Block

N-Boc-phenylene isothiocyanate 5 (1.25 g, 5 mmol) and THF of 200 ml are added to a three-pronged flask of 500 ml, and the reactive solution A has been adjusted. A Dropping funnel was set up in the side tube of this flask. The dropping funnel was filled with reactive solution B that diluted the NH₃ solution 6 of 1.2 g with THF of 100 ml and adjusted it. The Solution B was dropped while stirring the solution A under the room temperature, and it reacted under the room temperature. The reaction was then continued at room temperature for 12 hours. Reactive solution was sucking filtered, and a white powder was collected. A Distributed solution that added a white powder to hexane of 200 ml for the purpose of washing removal of impurities was adjusted, and N-Boc-phenylene thiourea 7 (1 g, 3.7 mmol) that is thiourea building block was synthesized. (FIG. 20 expression (3))

2-4) Synthesis of N-Boc-Phenylene (S-MPM) Thiourea Bromate that is S-Protecting Group Introduction Thiourea Building Block

The N-Boc-phenylene thiourea 7 (1.34 g, 5 mmol), 4-methoxybenzyl blomide, and DMF of 2 ml are added to the recovery flask of 50 ml, and the reactive solution A has been adjusted. The Return current stirring of the reactive solution A was performed and the heating reaction was performed for 3 hours. After the cold of the reactive solution was discharged at the room temperature, added ethyl acetate of 50 ml and stirred at the room temperature for 30 minutes. Then, suction filtration was carried out and the powder of the cream on the funnel was collected. The suck filtration was done after this powder was distributed to ethyl acetate of 100 ml, and it stirred it at two hour room temperature and a funnel cream-colored powder was collected. Thus, N-Boc-phenylene (S-MPM) thiourea bromate 9 (1.63 g, 3.5 mmol) of the objective was obtained. (FIG. 20 expression (4))

2-5) Adjustment of N-Boc-Phenylene (S-MPM) Thiourea that is S-Protecting Group Introduction Thiourea Building Block

N-Boc-phenylene (S-MPM) thiourea bromate 9 (1.63 g, 3.5 mmol) and NaHCO₃ (0.6 g, 2 times the amount of thiourea) were added to erlenmeyer flask of 500 ml filled with the mixture solution of water of 100 ml-ethyl acetate of 100 ml-THF solution of 50 ml. This solution is stirred at the room temperature for 30 minutes, and the organic layer was separated after that using the separatory funnel. Separating and extraction of this organic layer are again carried out with a saturated salt solution, and the dehydration processing was done adding anhydrous MgSO₄ after collecting the organic layers. Afterwards, the solution that removed MgSO₄ by filtration was moved to the recovery flask, and decompression and desiccation was done with evaporator. N-Boc-phenylene (S-MPM) thiourea 10 (1.1 g, 2.8 mmol) that is S-protecting group introduction thiourea building block of the objective was obtained in the recovery flask by evaporator which set hot-water bath temperature as room temperature. (FIG. 20 expression (5))

Since the concept and extendibility of amine building block, isothiocyanic building block, thiourea building block, and S-protecting group introduction thiourea building block were carried out and checked using FIG. 21, it explains Synthesis example 3 of the building block.

### 3) Synthesis of Building Block

Synthesis of Building Blocks of 1,2,4-Dithiazole Ring Formation Parts

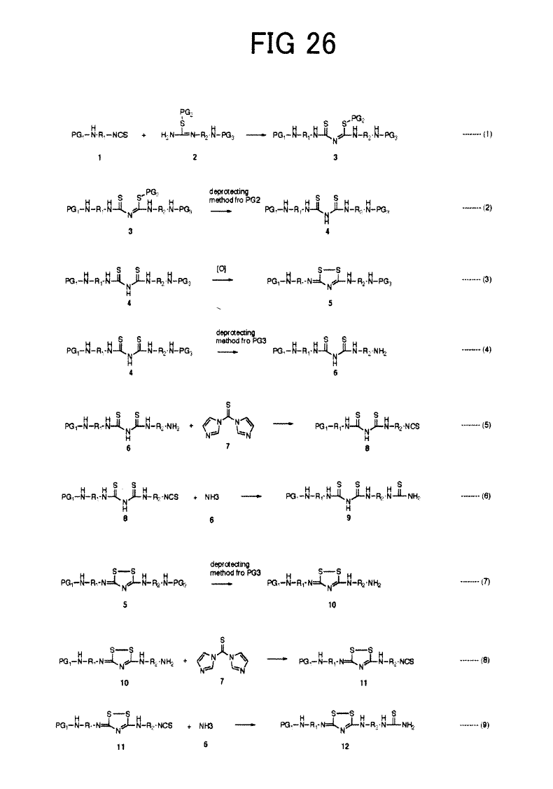

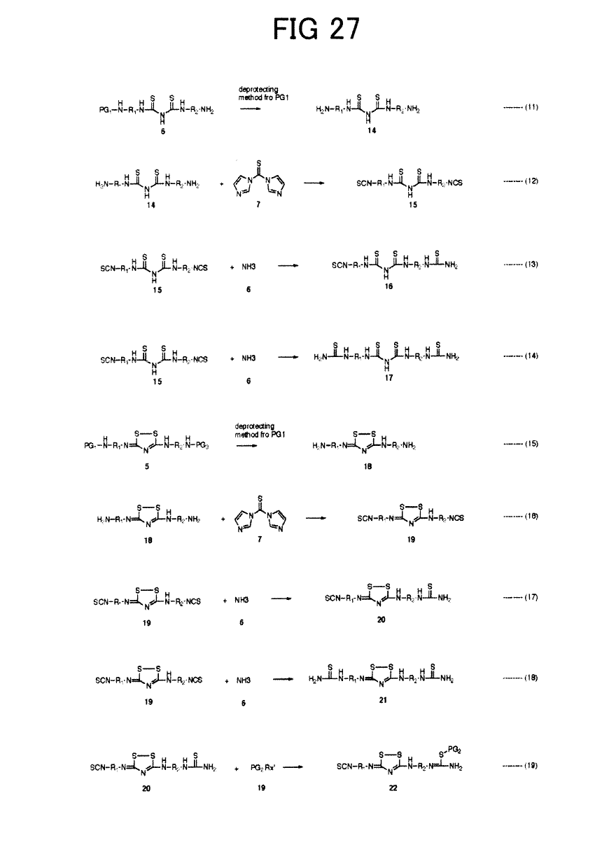

In the reaction shown in FIG. 21, it discovered that generalization and enlargement were possible by choosing suitably 1. a heat method, 2. solvent conditions, and 3. the additive for promotion of a reaction. The enlargement equation is shown in (4) from the expression (1). The compound 1-17 shown in the FIG. 21 is generalized the organism which has each functional group in a figure, and is expressed, PG1 and PG2 show the protecting group, and R1 and R2 show organic-inorganic frame molecule including aliphatic or aromatic series. Expression (1) shows the reaction that introduces the protecting group into the diamine. Only one amine was able to obtain the N-PG1 introduction diamine derivative 3 in which the protecting group was introduced by making it react to the diamine 2 of 2 equivalent amount, while the introduction reagent 1 of about 1 equivalent amount is dropped. (FIG. 21 expression (1)) The expression (2) shows the reaction which changes amine of the functional group of N-PG1 introduction diamine derivative to isothiocyanato. N-PG1 introduction isothiocyanic derivative 5 was able to be obtained by making 1,1′-thiocarbonyldiimidazole 4 of about 1 equivalent amount react to the N-PG1 introduction diamine derivative 3 of 1 equivalent amount. (FIG. 21 expression (2)) Thus, the N-PG1 introduction isothiocyanic derivative 5 that became 1,2,4-dithiazole ring formation parts (precursor) was able to be prepared. The expression (3) shows the reaction which changes isothiocyanato of the functional group of the N-PG1 introduction isothiocyanic derivative 5 to thiourea. N-PG1 introduction thiourea derivative 7 was able to be obtained by making ammonia solution of about 1-2 equivalent amount react to the N-PG1 introduction isothiocyanic derivative 5 of 1-2 equivalent amount. (FIG. 21 expression (3)) Thus, the N-PG1 introduction thiourea derivative 7 that became 1,2,4-dithiazole ring formation parts (precursor) was able to be prepared. The expression (4) shows the reaction which changes thiourea of the functional group of the N-PG1 introduction thiourea derivative 7 to S-PG2 introduction thiourea. N-PG1 introduction S-PG2 introduction thiourea derivative 9 was able to be obtained by making a introduction reagent 8 of about 1.5 equivalent amount react to the N-PG1 introduction thiourea derivative 7 of 1 equivalent amount. (FIG. 21 expression (4)) Thus, the N-PG1 introduction S-PG2 introduction thiourea derivative 9 that became 1,2,4-dithiazole ring formation parts (precursor) was able to be prepared. This newly invented equation (1)-(4) can also be adjusted using the compound which has a chemical formula like 10-17. It is desirable to use Fmoc and Boc for PG1 of a protecting group, and to use MPM for PG2. It explains the concept and extendibility of the synthesis of the amine building block, the isothiocyanic building block, the thiourea building block and the S-protecting group introduction thiourea building by using FIG. 26 and FIG. 27 at the end of embodiment 5.

### Embodiment 5

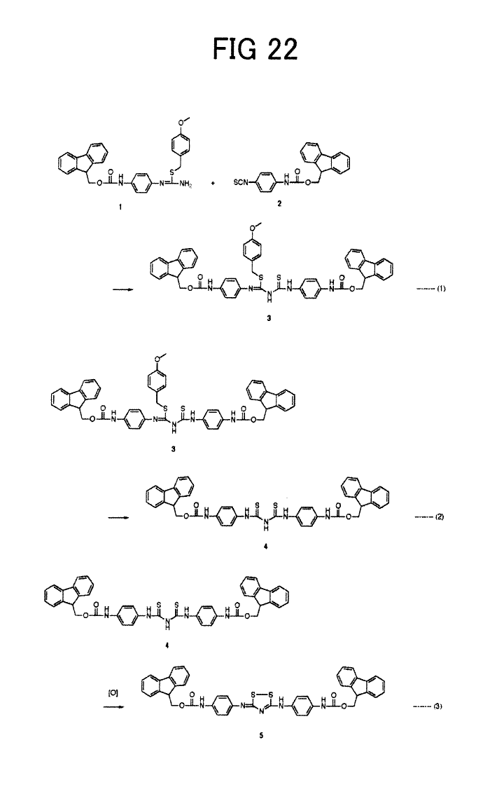

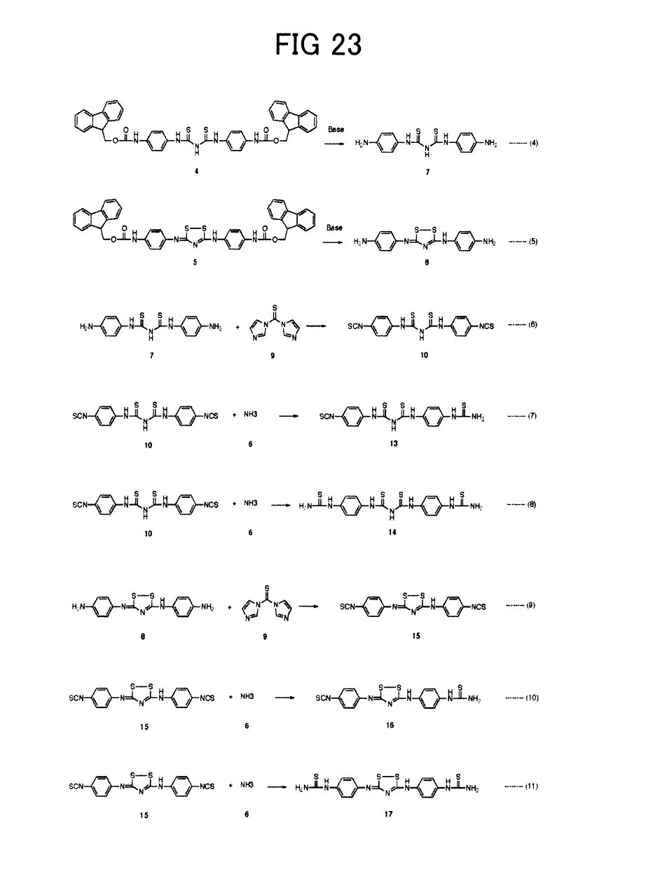

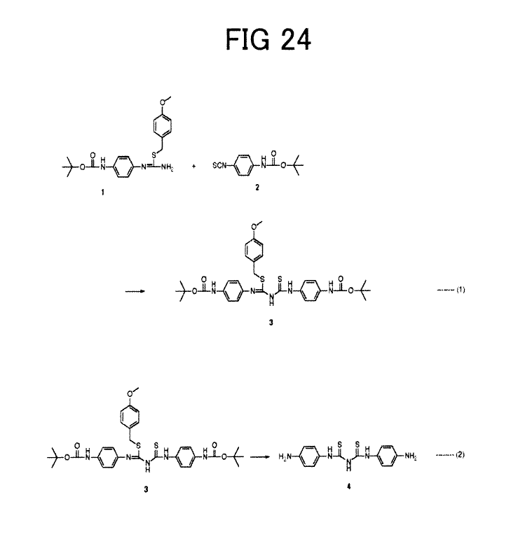

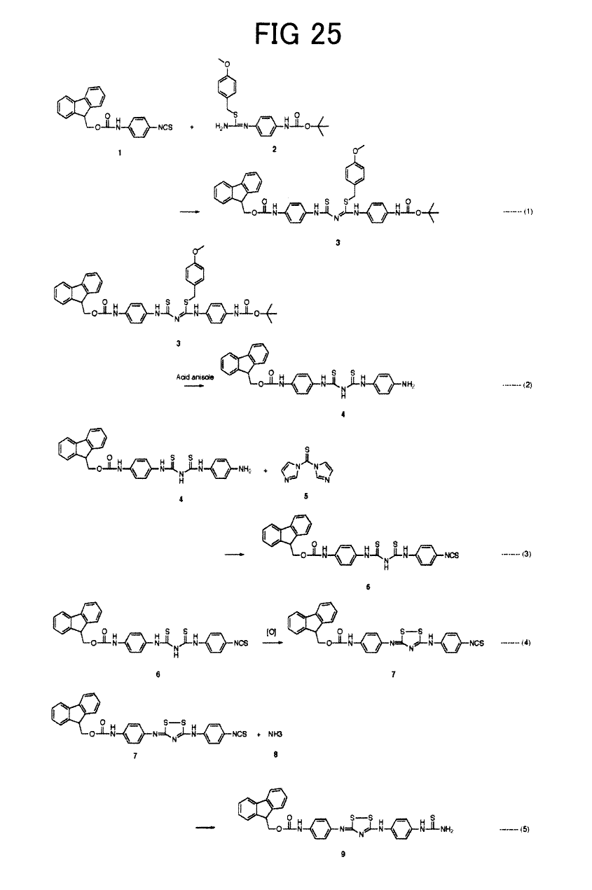

In embodiment 5, it explains the synthesis example of obtaining dithiobiuret building block, a S-protecting group introduction dithiobiuret building block, and 1,2,4-dithiazole ring building block because these are made to react properly by using the isothiocyanic building block, the thiourea building block, and the S-protecting group introduction thiourea building block explains by embodiment 4 as a departure medicine. Here, the dithiobiuret building block, the S-protecting group introduction dithiobiuret building block, and the 1,2,4-dithiazole ring building block show the compound that have a dithiobiuret (—NH(C═S)NH(c=S)NH—), the S-protecting group introduction dithiobiuret (—N═H(C—S—PG1)NH(C═S)NH—, PG: a protecting group), and the 1,2,4-dithiazole ring in the building block and/or have an amine, a protection amine, an isothiocyanato, thiourea, and a S-protecting group introduction thiourea as the synthesis reactive a point at the same time. It explains the embodiment of the synthesis that uses Fmoc and Boc as an example of a typical protecting group. Both the Fmoc and the Boc are used for the protecting group of amine, and the escape protection reaction progresses by the pH (pKa, pKb) environment in the solution. Usually, the Fmoc disconnects itself of amine under base, and the Boc disconnects itself of amine under acidity. Various synthetic designs can be performed by using that the pH condition of the disconnection is different. It explains example (1) that uses the Fmoc as an example of synthesizing the building block by the protecting group introduction and the deprotection reaction referring to FIG. 22 and FIG. 23. It explains example (2) that uses the Boc referring to FIG. 24. It explains example (3) that uses both the Fmoc and the Boc referring to FIG. 25. In FIG. 26 and FIG. 27 at the end of embodiment 5, it explains the concept and the extendibility of the synthesis example of obtaining the dithiobiuret building block, the S-protecting group introduction dithiobiuret building block, and the 1,2,4-dithiazole ring building block because these are made to react properly by using the isothiocyanic building block, the thiourea building block, and the S-protecting group introduction thiourea building block as a departure medicine. Since a possibility that the obtained building block has an oxidation-reduction reaction part and a chemical reaction part, and it can be used as a basic component of an electrode is high, the availability as a lot of electrode materials can be considered. The following are thought as the method. 1. Use a building block as an electrode material as it is. 2. Use the polymerization thing obtained by using a building block as an initiator (precursor) of a polymer as an electrode material. 3. Use the polymer obtained by using the building block of varieties as an initiator (precursor) of a polymer as an electrode material. 4. Use the composite construction object acquired by making connect a building block and other structures in which a reaction is possible at a reaction corner point as an electrode material. 5. Since complex formation with a metal ion is possible, use as a ligand and use obtained inorganic-organic polymer as an electrode material.

Synthesis of Building Block which Uses Fmoc for an Amine Protecting Group and Newly Forms One Dithiobiuret or One 1,2,4-Dithiazole Ring

It explains referring to FIG. 22 and FIG. 23.

### 2-1) Synthesis of N,N′-Fmoc S-Protecting Group Introduction Dithiobiuret Building Block

The solution that added N-Fmoc-phenylene (S-MPM) thiourea 1 of 1 mmol and N-Fmoc-phenylene isothiocyanate 2 of 1 mmol to THF 10 ml was heated at reflux for 8 hours. After the reaction had ended, because the reactive solution was extracted, was dehydrated, was evaporated, done, and the separation refinement was done by the flash chromatography, target N,N′-Fmoc S-protecting group introduction dithiobiuret building block 3 0.7 mmol was obtained. (FIG. 22 expression (1))

### 1-2) Synthesis of N,N′-Fmoc Dithiobiuret Building Block

N,N′-Fmoc S-protecting group introduction dithiobiuret building block 3 of 1 mmol was added to 4M-HCL dioxane 10 ml of an acid organic solvent, and was stirred at the room temperature for 10 minutes. Next, after anisole (2 mmol) was added, and it was stirred at the room temperature for a while, heating reaction was done at 80° C. for 1.5 hours. Because the reactive solution was neutralized, was extracted, was dehydrated, was evaporated, done, and the separation refinement was done by the flash chromatography, after neutralizing the reactive solution with the weak base, N,N′-Fmoc dithiobiuret building block 4 of 0.8 mmol that is final objective to escape and to separate protecting group was obtained. (FIG. 22 expression (2))

### 1-3) Synthesis of N,N′-Fmoc,2,4-Dithiazole Ring Building Block

N,N′-Fmoc ithiobiuret building block 4 of 1 mmol was added to dioxane 10 ml, and was stirred at the room temperature for 5 minutes. An equivalent amount of iodine was added to this solution, and the stir reaction was performed at room temperature for 1.5 hours. After the reaction, because the reactive solution was neutralized with the weak base, was extracted, was dehydrated, was evaporated, and the separation refinement was done by the flash chromatography, target N,N′-Fmoc-1,2,4-dithiazole ring building block 5 of 0.75 mmol was obtained. (FIG. 22 expression (3))

### 1-4) Synthesis of Dithiobiuret Building Block

N,N′-Fmoc ithiobiuret building block 4 of 1 mmol was added to dioxane of 10 ml, and was stirred at the room temperature for 5 minutes. 4 time equivalent amount of DBU was added to this solution, and the stir reaction was performed at room temperature for 0.5 hours. After the reaction, because the reactive solution was neutralized with the weak acid, was extracted, was dehydrated, was evaporated, and the separation refinement was done by the flash chromatography, target dithiobiuret building block 7 0.85 mmol was obtained. (FIG. 23 expression (4))

### 1-5) Synthesis of 1,2,4-Dithiazole Ring Building Block

N,N′-Fmoc,2,4-dithiazole ring building block 5 of 1 mmol was added to dioxane of 10 ml, and was stirred at the room temperature for 5 minutes. 4 time equivalent amount of DBU was added to this solution, and the stir reaction was performed at room temperature for 0.5 hours. After the reaction, because the reactive solution was neutralized with the weak acid, was extracted, was dehydrated, was evaporated, and the separation refinement was done by the flash chromatography, target dithiobiuret building block 8 0.8 mmol was obtained. (FIG. 23 expression (5))

### 1-6) Synthesis of Isothiocyanidation, Thiourea Building Block

The dithiobiuret building block 7 which held amine to molecule both ends by Fmoc disconnection was able to obtain 1,2,4-dithiazole ring or It has 1,2,4-dithiazole ring or dithiobiuret in a molecule, and is both-ends isothiocyanogen (10 of FIG. 24), isothiocyananogen and thiourea (13 of FIG. 24), and both-ends thiourea (14 of FIG. 24) which are the building blocks which have the following functional groups by carrying out functional group conversion of the amine of both ends. The transformation reaction from the amine to an individual functional group can already be synthesized in yield of 50%˜80% by the reaction condition equal with embodiment 4. The 1,2,4-dithiazole ring building block 8 which held amine to molecule both ends by Fmoc disconnection was able to obtain 1,2,4-dithiazole ring or It has 1,2,4-dithiazole ring or dithiobiuret in a molecule, and is both-ends isothiocyanogen (15 of FIG. 24), isothiocyananogen and thiourea (16 of FIG. 24), and both-ends thiourea (17 of FIG. 24) which are the building blocks which have the following functional groups by carrying out functional group conversion of the amine of both ends. The transformation reaction from the amine to an individual functional group can already be synthesized in yield of 50%˜80% by the reaction condition equal with embodiment 4.

2) Synthesis of Building Block which Uses Boc for an Amine Protecting Group and Newly Forms One Dithiobiuret or One 1,2,4-Dithiazole Ring

It explains referring to FIG. 24.

### 2-1) Synthesis of N,N′-Boc S-Protecting Group Introduction Dithiobiuret Building Block

The solution that added N-Boc-phenylene (S-MPM) thiourea 1 of 1 mmol and N-Boc-phenylene isothiocyanate 2 of 1 mmol to THF 10 ml was heated at reflux for 8 hours. Because the reactive solution was extracted, was dehydrated, was evaporated, done, and the separation refinement was done by the flash chromatography, target N,N′-Boc S-protecting group introduction dithiobiuret building block 3 0.75 mmol was obtained. (FIG. 24 expression (1))

### 2-2) Synthesis of Dithiobiuret Building Block

In the case of a Boc building block, when the protecting group of S is MPM, MPM disconnection and Boc disconnection can be performed at the same time. N,N′-Boc N′S-protecting group introduction dithiobiuret building block 3 of 1 mmol was added to 4M-HCL dioxane 10 ml of an acid organic solvent, and was stirred at the room temperature for 10 minutes. Next, after anisole (2 mmol) was added, and it was stirred at the room temperature for a while, heating reaction was done at 80° C. for 1.5 hours. Because the reactive solution was neutralized, was extracted, was dehydrated, was evaporated, done, and the separation refinement was done by the flash chromatography, after neutralizing the reactive solution with the weak base, Dithiobiuret building block 4 of object 0.8 mmol was obtained. (FIG. 24 expression (2))

Though it explained a series of reaction by S-protecting group with the embodiment as an example of the synthesis of the dithiobiuret building block and the 1,2,4-dithiazole ring building block, when the protecting group of amine is Boc, the dithiobiuret building block of the objective can be synthesized with there no S-protecting group by using isothiocyanogen building block and thiourea building block with the strong base addition solution as well as embodiment 3. Other amid system strong bases and fosufazen system bases can be used as non-ion strong base besides DBU can be used as a strong base. Moreover, it is although KOH, LiOH, NaOH, ter-AmOK, ter-AmOLi and KF solid base, etc. can be used as an ionicity strong base, it is generally low yield to use them, and since reaction post-processing also becomes complicated, an inorganic solid is not the method for which it was suitable. It is a reaction method with more desirable the following methods including the reaction method of the description to this embodiment. As for the synthetic reaction of S-protecting group introduction dithiobiuret building block, the solventless reaction and the micro wave heating are possible in a usual heating reaction in this embodiment. However, the method of using the reactor with good heating efficiency such as the microwave heatings and the micro reactor reactions is effective in both reactive efficiency and reactive time, and is made desirable processing in this synthetic reaction. Furthermore, reaction conditions which serve as a synthetic high-concentration reaction system on the micro level using biphasic responses, such as a reversed micelle reaction makes both reactive time and reactive efficiency effective, and is made desirable processing in this synthetic reaction. IN a solvent condition, as for the kind of the solvent, ethers of the Inside-high polarities such as NMP, DMAc, DMF, and THF, etc. and amid system solvents become desirable solvents. As this amount of the solvent, the amount of solvents is used comparatively less in this embodiment, or the solvent condition in solvent-free synthesis or minimum amount solvent based on it makes reaction time and yield effective. As an additive agent for the reaction promotion, If the strong base is used as an additive agent, the reaction is promoted. Also in it, other amide system strong bases and phosphazene system bases can also be used as nonionic strong bases including DBU. Moreover, it is although KOH, LiOH, NaOH, ter-AmOK, ter-AmOLi and KF solid base, etc. can be used as an ionicity strong base, it is generally low yield to use them, and since reaction post-processing also becomes complicated, an inorganic solid is not the method for which it was suitable.

3) Synthesis of the Building Block which Uses Fmoc and Boc for an Amine Protecting Group, and Newly Forms Dithiobiuret or One 1,2,4-Dithiazole Ring

It explains referring to FIG. 25.

3-1) Synthesis of N,-Boc and N′-Fmoc S-Protecting group Introduction Dithiobiuret Building Block

The solution that added N-Fmoc-phenylene isothiocyanate 1 of 1 mmol and N-Boc-phenylene (S-MPM) thiourea 2 of 1 mmol to THF 10 ml was heated at reflux for 8 hours. Because the reactive solution was extracted, was dehydrated, was evaporated, done, and the separation refinement was done by the flash chromatography, target N,-Boc and N′-Fmoc S-Protecting group introduction dithiobiuret building block 3 of 0.75 mmol was obtained. (FIG. 25 expression (1))

### 3-2) Synthesis of N′-Fmoc-Dithiobiuret Building Block

N,-Boc-N′-Fmoc-S-Protecting group introduction dithiobiuret building block 3 of 1 mmol was added to 4M-HCL dioxane 10 ml of an acid organic solvent, and was stirred at the room temperature for ten minutes. Next, after anisole (2 mmol) was added, and it was stirred at the room temperature for a while, heating reaction was done at 80° C. for 1.5 hours. Because the reactive solution was neutralized, was extracted, was dehydrated, was evaporated, done, and the separation refinement was done by the flash chromatography, after neutralizing the reactive solution with the weak base, target N′-Fmoc-dithiobiuret building block 4 0.7 mmol was obtained. (FIG. 25 expression (2))

### 3-3) Synthesis of Isothiocyanidation and Thioureaized Building Block

By carrying out functional group conversion of the amine, N-Fmoc-dithiobiuret building block 4 has dithiobiuret in a molecule, and was able to obtain isothiocyanidation building block (6 and 7 of FIG. 25) and thioureaized building block (9 of FIG. 25). The transformation reaction from the amine to an individual functional group can already be synthesized in yield of 50%-80% by the reaction condition equal with embodiment 4.

4) The Concept and its Extended Possibility which Introduce the Connecting Point that Dithiobiuret or 1,2,4-Dithiazole Ring can Further be Constructed in the Building Block which has Dithiobiuret or 1,2,4-Dithiazole Ring

It explains referring to FIG. 26 and FIG. 27.

4-1) Method of Introducing the Connecting Point into One Side of Building Block that has Dithiobiuret or 1,2,4-Dithiazole Ring.

FIG. 26 shows a series of synthetic procedure. The reactive type made to The extensionized equation is shown in the formulas (1)-(9). The compound shown in a figure is generalized the organism which has each functional group in a figure, and is expressed, PG1 and PG2 show the protecting group, and R1 and R2 show organic-inorganic frame molecule including aliphatic or aromatic series. The protecting group that used it as an embodiment used Fmoc and Boc for PG1 and PG2, and used MPM for PG3. S-protecting group introduction dithiobiuret building block synthesis reaction is shown in expression (1). S-protecting group introduction dithiobiuret building block was able to be obtained by carrying out the heating reaction of an equivalent amount of isothiocyanidation building block 1 and S-protecting group introduction thiourea building block 2. (FIG. 26 expression (1)) the dithiobiuret building block synthesis reaction is shown in expression (2). The dithiobiuret building block 4 was able to be obtained by performing proper addition reactions, such as a pH adjuster, light, and heat, to s-protecting group introduction dithiobiuret building block 3 of 1 equivalent amount. The strong acid and anisole were suitable for MPM. (FIG. 26 expression (2) The 1,2,4-dithiazole ring building block synthesis reaction is shown in expression (3). The 1,2,4-dithiazole ring building block 5 was able to be obtained by adding oxidants such as hydrogen peroxide, the iodine, and the bromine of about 1?2 equiponderance, and making it react for dithiobiuret building block 4 of 1 equiponderance. (FIG. 26 expression (3)) Expression (4) and expression (7) show the reaction that generate the amino group to a molecular edge. Expression (4) and expression (7) show synthesis reaction of 1,2,4-dithiazole ring building block. The amino terminal end-dithiobiuret building block 6 and the amino terminal end-1,2,4-dithiazole ring building block 10 were able to be obtained by doing an addition reaction proper like an excessive amount of pH adjustment medicines, light, and heat, etc. to The dithiobiuret building block 4 of 1 equiponderance or The 1,2,4-dithiazole ring building block 5 of 1 equiponderance. (FIG. 26 expression (4), FIG. 26 expression (7)) The reaction in which amine of The amino terminal end-dithiobiuret building block 6 and the amino terminal end-1,2,4-dithiazole ring building block 10 carries out functional group change at isothiocyanogen in the expression (5) and the expression (8). Isothiocyanidation-dithiobiuret building block 8 and isothiocyanidation-1,2,4-dithiazole ring building block 11 were able to be obtained by making 1,1′-thiocarbonydiimidazole 4 of about 1.25 equivalent amount react to the amino terminal end-dithiobiuret building block 6 and the amino terminal end-1,2,4-dithiazole ring building block 10 of 1 equivalent amount. (FIG. 26 expression (5), expression (8)) The reaction in which isothiocyanogen of Isothiocyanidation-dithiobiuret building block 8 and isothiocyanidation-1,2,4-dithiazole ring building block 11 carries out functional group change at thiourea in the expression (6) and the expression (9). thiourea-dithiobiuret building block 9 and thiourea-1,2,4-dithiazole ring building block 12 were able to be obtained by making ammonium solution 6 of about 1.5 equivalent amount react to isothiocyanidation-dithiobiuret building block 8 and isothiocyanidation-1,2,4-dithiazole ring building block 11 of 1 equivalent amount. (FIG. 26 expression (6), FIG. 27 expression (9)) Thus, it was confirmed to be able to adjust each derivative building block that became 1,2,4-dithiazole ring formation parts (precursor) one by one. Although not shown in a figure, by S protecting grouping reaction being performed, it is checking that the thiourea-1,2,4-dithiazole ring building block 12 is also able to be easily set to the S protecting grouping thiourea-1,2,4-dithiazole ring building block.

4-2) Method of Introducing the Connecting Point into Both Sides of Building Block that has the Dithiobiuret or the 1,2,4-Dithiazole Ring

FIG. 27 shows a series of synthetic procedure. The compound shown in a figure is generalized the organism which has each functional group in a figure, and is expressed, PG1 and PG2 show the protecting group, and R1 and R2 show organic-inorganic frame molecule including aliphatic or aromatic series. The protecting group that used it as an embodiment used Fmoc and Boc for PG1 and PG2, and used MPM for PG3. Expression (11) and expression (15) show the synthetic reaction that forms the amino group at both ends of the building block. The both sides amino end-dithiobiuret building block 14 and the both sides amino end-1,2,4-dithiazole ring building block 18 were able to be obtained by doing an addition reaction proper like an excessive amount of pH adjustment medicines, light, and heat, etc. to the one side amino end-dithiobiuret building block 6 or the 1,2,4-dithiazole ring building block 5. (FIG. 27 expression (11), expression (15)) The reaction in which amine of The both sides amino end-dithiobiuret building block 14 and the both sides amino end-1,2,4-dithiazole ring building block 18 carries out functional group change at isothiocyanogen in the expression (12) and the expression (16). The both sides isothiocyanidation-dithiobiuret building block 15 and the both sides isothiocyanidation-1,2,4-dithiazole ring building block were able to be obtained by making 1,1′-thiocarbonydiimidazole 4 of about 2.5 equivalent amount react to the amino terminal end—dithiobiuret building block 14 and the amino terminal end-1,2,4-dithiazole ring building block 18 of 1 equivalent amount. (FIG. 27 expression (12), expression (16)) The reaction in which isothiocyanogen of the both sides isothiocyanidation-dithiobiuret building block 15 and the both sides isothiocyanidation-1,2,4-dithiazole ring building block 16 carries out functional group change at thiourea in the expression (13) and the expression (17). The isothiocyanidation-thiourea-dithiobiuret building block 16 and The isothiocyanidation-thiourea-1,2,4-dithiazole ring building block 20 were able to be obtained by making ammonium solution 6 of about 0.5 equivalent amount drop and react for the both sides isothiocyanidation-dithiobiuret building block 15 and the both sides isothiocyanidation-1,2,4-dithiazole ring building block 19 of one equivalent amount. (FIG. 27 expression (13), expression (17)) The reaction in which isothiocyanogen of the both sides isothiocyanidation-dithiobiuret building block 15 and the both sides isothiocyanidation-1,2,4-dithiazole ring building block 19 carries out functional group change at thiourea in the expression (14) and the expression (18). The both sides thiourea-dithiobiuret building block 17 and the both sides thiourea—1,2,4-dithiazole ring building block 21 were able to be obtained by making ammonium solution 6 of about 2 equivalent amount react to the both sides isothiocyanidation-dithiobiuret building block 15 and the both sides isothiocyanidation-1,2,4-dithiazole ring building block 19 of 1 equivalent amount. (FIG. 27 expression (14), expression (18)) In addition, by S protecting grouping reaction being performed, it is checking that the thiourea-1,2,4-dithiazole ring building block is also able to be easily set to the S protecting grouping thiourea-1,2,4-dithiazole ring building block. (FIG. 27 expression (19)) Thus, it was confirmed to be able to adjust each derivative building block that became 1,2,4-dithiazole ring formation parts (precursor) one by one. Though it explained a series of reaction by S-protecting group with the embodiment as an example of the synthesis of the dithiobiuret building block and the 1,2,4-dithiazole ring building block, when the protecting group of amine is strong base-proof, the dithiobiuret building block of the objective can be synthesized with there no S-protecting group by using an isothiocyanogen building block and a thiourea building block with the strong base addition solution as well as embodiment 3. Other amid system strong bases and [fosufazen] system bases can be used as non-ion strong base besides DBU can be used as a strong base. Moreover, it is although KOH, LiOH, NaOH, ter-AmOK, ter-AmOLi and KF solid base, etc. can be used as an ionicity strong base, it is generally low yield to use them, and since reaction post-processing also becomes complicated, an inorganic solid is not the method for which it was suitable. It is a reaction method with more desirable the following methods including the reaction method of the description to this embodiment. As for the synthetic reaction of S-protecting group introduction dithiobiuret building block, the solventless reaction and the microwave heating are possible in a usual heating reaction in this embodiment. However, the method of using the reactor with good heating efficiency such as the microwave heatings and the micro reactor reactions is effective in both reactive efficiency and reactive time, and is made desirable processing in this synthetic reaction. Furthermore, reaction conditions which serve as a synthetic high-concentration reaction system on the micro level using biphasic responses, such as a reversed micelle reaction makes both reactive time and reactive efficiency effective, and is made desirable processing in this synthetic reaction. IN a solvent condition, as for the kind of the solvent, ethers of the convex polarity such as NMP, DMAc, DMF, and THF, etc. and amid system solvents become desirable solvents. As this amount of the solvent, the amount of solvents is used comparatively less in this embodiment, or the solvent condition in solvent-free synthesis or minimum amount solvent based on it makes reaction time and yield effective. As an additive agent for the reaction promotion, if the strong base is used as an additive agent, the reaction is promoted. Also in it, other amide system strong bases and phosphazene system bases can also be used as nonionic strong bases including DBU. Moreover, it is although KOH, LiOH, NaOH, ter-AmOK, ter-AmOLi and KF solid base, etc. can be used as an ionicity strong base, it is generally low yield to use them, and since reaction post-processing also becomes complicated, an inorganic solid is not the method for which it was suitable. Since the building block obtained in this way has an oxidation-reduction reaction part (disulphide bond and phenylenediamine part) and a chemical reaction part (isothiocyanate or thiourea), its a possibility that it can use as a basic component of an electrode is high, and it can consider the availability as a lot of electrode materials. 1. The building block is used as it is as an electrode material, 2. The building block is used as an initiator (precursor) of the polymer, and the obtained polymerization is used as an electrode material, 3. Many kinds of building blocks are used as an initiator (precursor) of the polymer, and the obtained polymerization is used as an electrode material, and 4. The compound structure obtained by connecting the building block and other structures that can react in a reactive anchor is used as an electrode material, etc. are thought as the method.

### Embodiment 6

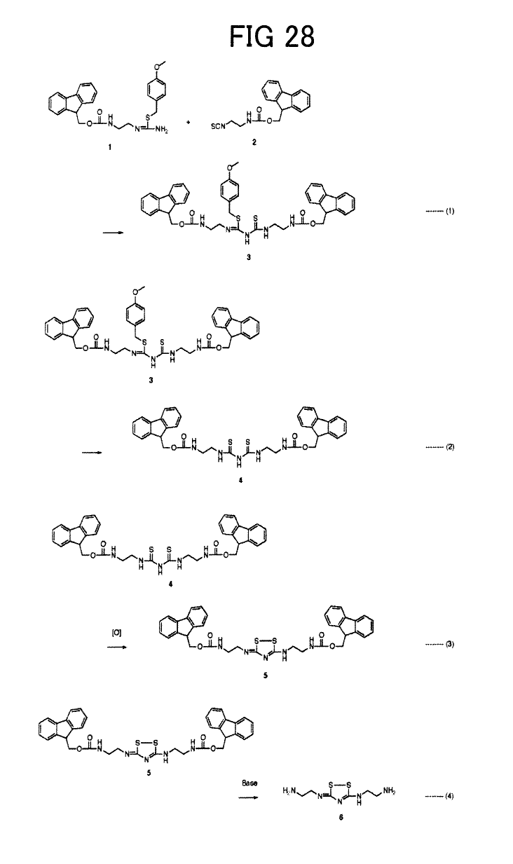

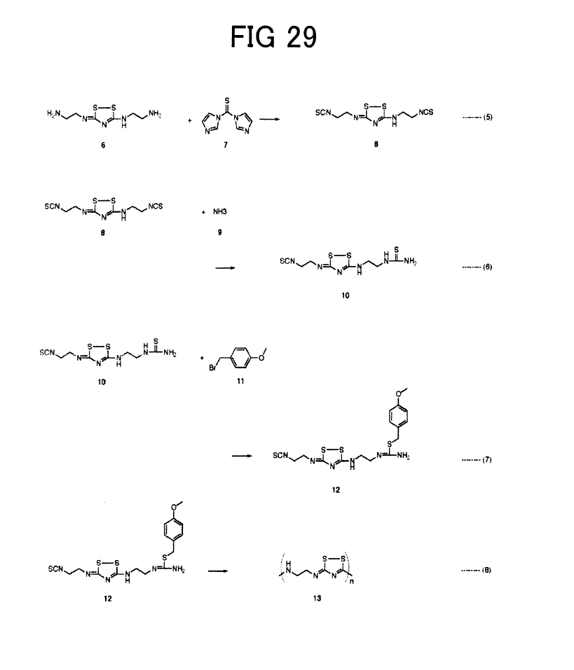

It explains the synthesis of the polymer that uses the building block referring to FIG. 28 and FIG. 29.

### 1) Synthesis of N-Thioformylthioformamide-Phenylendiamine Copolymer

### 1-1) Synthesis of N—N′-Fmoc S-Protecting Group Introduction Dithiobiuret Building Block

The solution that added N-Fmoc-phenylene (S-MPM) thiourea 1 of 1 mmol and N-Fmoc-phenylene isothiocyanate 2 of 1 mmol adjusted by show in embodiment 5 method to THF 10 ml was heated at reflux for 8 hours. After the reaction had ended, after the cold of a reactive liquid was discharged at the room temperature, because the reactive solution was extracted, was dehydrated, was evaporated, done, and the separation refinement was done by the flash chromatography, target N—N′-Fmoc S-protecting group introduction dithiobiuret building block 3 0.7 mmol was obtained. (FIG. 28 expression (1))

### 1-2) Synthesis of N′-Fmoc-Dithiobiuret Building Block

N, —N′-Fmoc-S-Protecting group introduction dithiobiuret building block 3 of 1 mmol was added to 4M-HCL dioxane 10 ml of an acid organic solvent, and was stirred at the room temperature for ten minutes. Next, after anisole (2 mmol) was added, and it was stirred at the room temperature for a while, heating reaction was done at 80° C. for 1.5 hours. After the reaction, because the reactive solution was extracted, was dehydrated, was evaporated, done, and the separation refinement was done by the flash chromatography, after neutralizing the reactive solution which carried out cooling ice melting to room temperature with the weak base, N′-Fmoc-dithiobiuret building block 4 of the final object which disconnected the protecting group 0.8 mmol was obtained. (FIG. 28 expression (2))

### 1-3) Synthesis of N,N′-Fmoc-1,2,4-Dithiazole Ring Building Block

N,—N′-Fmoc dithiobiuret building block 4 of 1 mmol was added to dioxane 10 ml of an acid organic solvent, and was stirred at the room temperature for five minutes. An equivalent amount of iodine was added to this solution, and the stir reaction was performed at room temperature for 1.5 hours. After the reaction, because the reactive solution was neutralized with the weak base, was extracted, was dehydrated, was evaporated, and the separation refinement was done by the flash chromatography, target N,N′-Fmoc-1,2,4-dithiazole ring building block 5 0.65 mmol was obtained. (FIG. 28 expression (3))

### 1-4) Synthesis of 1,2,4-Dithiazole Ring Building Block

N,—N′-Fmoc 1,2,4-dithiazole ring building block 5 of 1 mmol was added to dioxane 10 ml of an acid organic solvent, and was stirred at the room temperature for five minutes. Four time equivalent amount of DBU was added to this solution, and the stir reaction was performed at room temperature for 1 hours. After the reaction, because the reactive solution was neutralized with the weak acid, was extracted, was dehydrated, was evaporated, and the separation refinement was done by the flash chromatography, target 1,2,4-dithiazole ring building block 6 0.85 mmol was obtained. (FIG. 28 expression (4))

### 1-5) Synthesis of Both Sides Isothiocyanogen Derivatization-1,2,4-Dithiazole Ring Building Block

The 1,2,4-dithiazole ring building block 6 of 1 mmol and 1,1′-thiocarbonyldiimidazole 7 about 2.5 equivalent amount are made to react, because the reactive solution was neutralized with the weak acid, was extracted, was dehydrated, was evaporated, and the separation refinement was done by the flash chromatography, target both sides isothiocyanogen derivatization-1,2,4-dithiazole ring building block 8 0.7 mmol was obtained. (FIG. 29 expression (5))

### 1-6) Synthesis of Isothiocyanidation-Thiourea-1,2,4-Dithiazole Ring Building Block

Ammonia solution of about 0.5 equivalent amount was dropped to the both sides isothiocyanogen derivatization-1,2,4-dithiazole ring building block 8 at room temperature, and the stir reaction was performed at room temperature for 3 hours afterwards. After the reaction, because the reactive solution was extracted, was dehydrated, was evaporated, and the separation refinement was done by the flash chromatography, target isothiocyanidation-thiourea-1,2,4-dithiazole ring building block 10 0.85 mmol was obtained. (FIG. 29 expression (6))

### 1-7) Synthesis of Isothiocyanidation-5-Protecting Group Introduction Thiourea-1,2,4-Dithiazole Ring Building Block

When the heating reaction of the isothiocyanidation-thiourea-1,2,4-dithiazole ring building block 10 of 1 mmol and the 4-methoxybenzyl blomide 11 of 1.5 mmol was carried out at 70° C. in THF, the organic salt of the object extracted. Because this was neutralized with the weak base, was dehydrated, and was evaporated, and the separation refinement was done by the flash chromatography, target isothiocyanidation-5-protecting group introduction thiourea-1,2,4-dithiazole ring building block 12 0.7 mmol was obtained. (FIG. 29 expression (7))

### 1-8) Synthesis of Polymer

The isothiocyanidation-5-protecting group introduction thiourea-1,2,4-dithiazole ring building block 12 of 1 mmol was dissolved in DMF 2 ml, and the microwave reaction (Discover made by SEM company, 90° C. in preset temperature, 10 minutes in reactive time) was performed. the reactive solution was poured into the methanol, and a target polymer was collected, and washed. Afterwards, this salvaged material is added to 4M-HCL dioxane 10 ml of an acid organic solvent, next, the protecting group (MPM) is disconnected by adding anisole (3 mmol), and doing the return current stirring and the heating reaction for 1.5 hours, furthermore, the polymer 13 of the final object was obtained by washing it and drying. (FIG. 29 expression (8))

### Embodiment 7

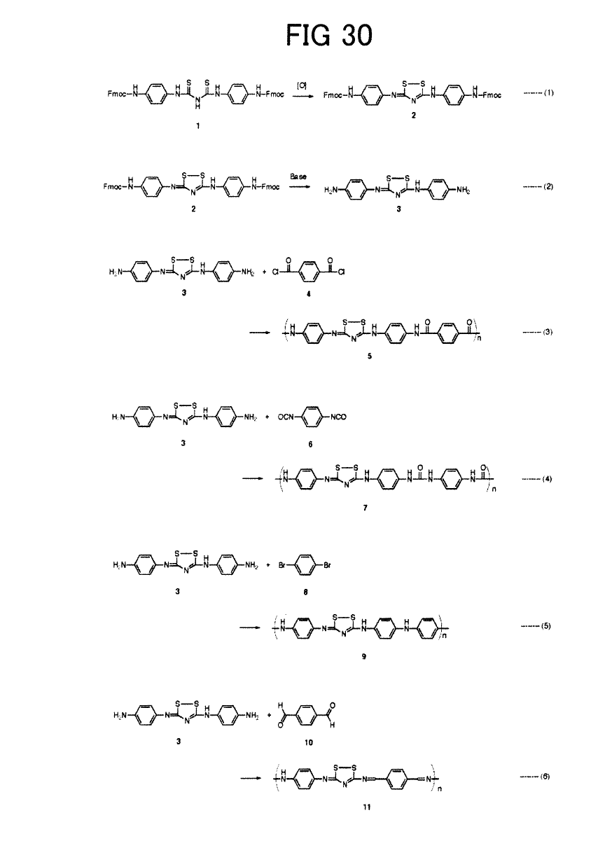

It explains the synthesis of the polymer using the building block which has the 1,2,4-dithiazole ring which made amine which is a connecting point hold on both sides referring to FIG. 30.

1) Synthesis of the Polymer Using the Building Block which has the 1,2,4-Dithiazole Ring which Made Amine which is a Connecting Point Hold on Both Sides

In accordance with the method illustrated in the case of the embodiment 5, both ends amination-1,2,4-dithiazole ring building block 3 1 mmol of the objective has been adjusted. Because it is making this both ends amination-1,2,4-dithiazole ring building block 3 as a polymer reaction precursor copolymerize with other polymer precursors which can react with amino group, It becomes possible to adjust various polymer.

### 2) Polymer Synthesis by Both Ends Amination-1,2,4-Dithiazole Ring Building Block and Carboxylic Acid Halid

After adding both ends amination-1,2,4-dithiazole ring building block 3 1 mmol, terephthaloyl Chloride 4 1 mmol, and TEA 2.5 mmol to NMP 10 ml and stirring at room temperature for 30 minutes, the heating stir was done for 4 hours at 80° C. Afterwards, the reactive solution was poured into the ethanol, the sludge was washed with the ethanol and THF, the vacuum dried, and the polymer 5 of the objective was obtained by the yield of 75%. (FIG. 30 expression (3))

### 3) Polymer Synthesis by Both Ends Amination-1,2,4-Dithiazole Ring Building Block and Diisocyanide

After adding both ends amination-1,2,4-dithiazole ring building block 3 1 mmol and phenylen diisosianate 6 of 1 mmol to dehydration THF 10 ml and stirring at room temperature for 30 minutes, the heating stir was done for 4 hours at 80° C. Afterwards, the reactive solution was poured into the ethanol, the sludge was washed with the ethanol and THF, the vacuum dried, and the polymer 7 of the objective was obtained by the yield of 80%. (FIG. 30 expression (4))

### 4) Polymer Synthesis by Both Ends Amination-1,2,4-Dithiazole Ring Building Block and Dihalide

The polymerization reaction was performed at the microwave reaction using Discover by a SEM company. The glass tube (10-ml sealing vial with exclusive septum) for Discover also in a glass container was used. Dehydration THF 4 ml was added to the glass tube of 10 ml for the Mw synthesis in the glove box under the argon gas flow, and, next, the both ends amination-1,2,4-dithiazole ring building block 3 1 mmol, 1,4-dibromobenzene 8 1 mmol, tris (dibenzylidene acetone) dipalladium (0) 0.01 mmol, 2-(Di-tert-butylphosphino) biphenyl 0.06 mmol and sodium tert-butoxide 1.4 mmol were added. This glass tube was covered by silicon septum, and also the Teflon seal was wrapped. This sealing up vial was set up in Discover made by the SEM company by a predetermined method, the microwave reaction was executed while performing magnet stir at 80° C. in preset temperature and 10 minutes in reactive time. After the reaction ended, after THF in the sealing up vial was decompressing removed, diethylether 8 ml was poured, the sludge that adhered to the wall and the tube bottom was scratched and taken with the spatula, and the target polymer was collected. This salvaged material was washed with the ethanol and acetone, the vacuum dried, and the polymer 9 of the objective was obtained by the yield of 70%. (FIG. 30 expression (5))

### 5) Polymer Synthesis by Both Ends Amination-1,2,4-Dithiazole Ring Building Block and Dialdehyde Compound

The polymerization reaction was performed at the microwave reaction using Discover by a SEM company. The glass tube (10-ml sealing vial with exclusive septum) for Discover also in a glass container was used. Dehydration DMAC 10 ml was added to the glass tube of 10 ml for the Mw synthesis in the glove box under the argon gas flow, and, next, the both ends amination-1,2,4-dithiazole ring building block 3 1 mmol, terephthalaldehyde 10 of 1 mmol, LiCl of 2 mmol were added. This glass tube was covered by silicon septum, and also the Teflon seal was wrapped. This sealing up vial was set up in Discover made by the SEM company by a predetermined method, the microwave reaction was executed while performing magnet stir at 80° C. in preset temperature and 10 minutes in reactive time. After the reaction ended, the reactive solution is poured into the methanol, and the sludge was washed with the methanol and THF, the vacuum dried, and the polymer 11 of the objective was obtained by the yield of 75%. (FIG. 30 expression (6))

### Embodiment 8

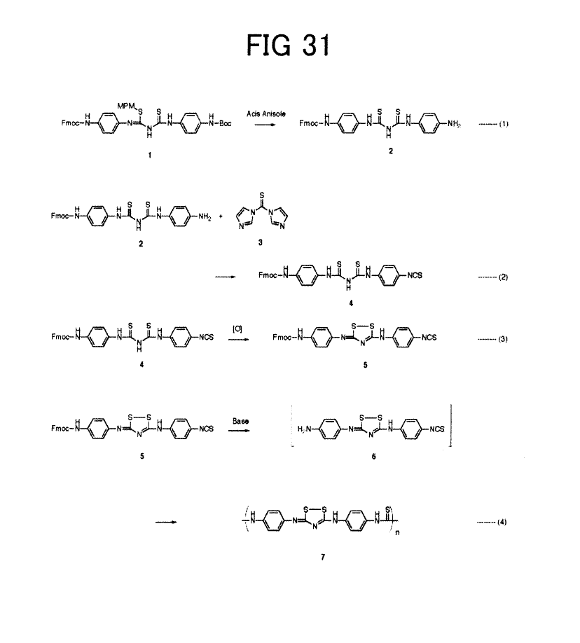

It explains the synthesis of the polymer using the building block which has the 1,2,4-dithiazole ring which made amine which is a connecting point hold on both sides referring to FIG. 31.

### 1) Synthesis of Synthesis of N-Fmoc-Isothiocyanogen Building Block

In accordance with the method illustrated in the case of the embodiment 5, after N,-Boc,N′-Fmoc-5-protecting group introduction dithiobiuret building block, N-Fmoc-dithiobiuret building block and isothiocyanidation N-Fmoc-dithiobiuret building block were synthesized, isothiocyanidation N-Fmoc-1,2,4-dithiazole ring building block 5 1 mmol of the objective has been adjusted. (FIG. 31 expression (1), (2), (3))

### Synthesis of Polymerization Thing by Thiourea Reaction

After isothiocyanidation N-Fmoc-1,2,4-dithiazole ring building block 5 1 mmol is added to dioxane of 10 ml, DBU of 1 mmol is dropped, and stirring was done at room temperature for 30 minutes, the heating stir was done for 4 hours at 80° C. After the reaction ended, the reactive solution is poured into the ethanol, and the sludge was washed with the ethanol and THF, the vacuum dried, and the polymer 7 of the objective was obtained by the yield of 85%. (FIG. 31 expression (4))

### Comparative Example (1)

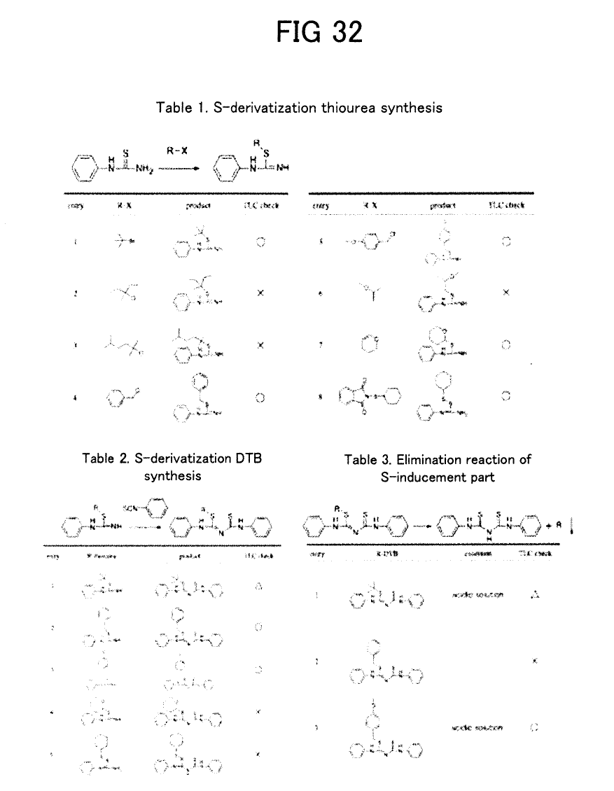

It explains comparison of the protecting group (monomers) referring to FIG. 32. The examined sample was summarized to entry8 from entry1 in Table 1. All the samples of entry8 from entry1 used the commercial item for synthesis as it was. It explains an actual synthesis approach as an example of (entry5 in Table 1→entry3 in Table 2→entry3 in Table 2).

### 1-1) S-Derivatization Thiourea Synthesis

1-pheneylen-2-thiourea of 0.15 g (1 mmol) and 4-methoxybenzyl chloride of 0.19 g (1.2 mmol) were added to THF of 2 ml. The heating at reflux was done while stirring this solution. It reacted by the heating stir of about 2 hours. After adding about 20 ml of hexane to reaction solution and extracting the objective, the sludge and the reactive solution were filtrated by the suction filtration. The solid on the paper filter was added to hexane about 20 ml and they were stirring washed at the room temperature.

The reactant was dried and S-derivatization thiourea hydrochloride of 0.246 g (0.8 mmol) was obtained.

### 1-2) S-Derivatization DTB Synthesis

S-derivatization thiourea hydrochloride of 0.31 g (1 mmol) was putted into the mixture solution of Sodium hydrogencarbonate saturated water solution/THF/ether=25 ml/25 ml/25 ml, it stirred at the room temperature, and the desalination processing was done. After about 15 minutes, the S-derivatization thiourea that did the desalination processing was obtained by extracting this solution, dehydrating, and doing the decompression dryness. The solution that add phenyl isothiocyanate of 0.135 g (1 mmol) to chloroform 20 ml was heated at reflux for 8 hours. Refining separation of the obtained rough product is carried out by open column chromatography and S-derivatization DTB of 0.29 g (0.72 mmol) of the objective was obtained.

### 1-3) Elimination Reaction of S-Inducement Part

S-derivatization DTB of 0.42 g (1 mmol) and anisole of 0.2 g (2 mmol) were putted into the mixture solution of trifluoroacetic acid/chloroform=5 ml/5 ml. This solution was heated at reflux for 30 minutes. After the reaction ended, after cooling the solution up to the room temperature, DiphDTB A of the objective was obtained by neutralizing, extracting, dehydrating, and doing the decompression dryness.

### 1-4) Experimental Result

The result of review was summarized from Table 1 in Table 3. The synthetic reaction was performed in order of S-derivatization thiourea synthesis (Chemical reaction in Table 1), S-derivatization DTB synthesis (Chemical reaction in Table 2), and elimination reaction of S-inducement part (Chemical reaction in Table 3). A TLC check is used for the check of a synthetic reaction, examination of the next reaction was canceled in what has the few amount of output, and the thing which generates by-product material. As for that in which the reaction advanced easily, ◯ mark is written in the TLC check column in the table. As for what has a few quantity of output, and what the side reaction was regarded as, x mark is indicated. Although Rapidity of response was slow, that which is likely to be possible indicated Δ mark and considered it to the elimination reaction of the last R group. The Examined R groups are the 3rd class carbon, the structure of having a MPM group, and a disulfide group. The result of S-derivatization thiourea synthesis of the first reaction is shown in Table 1. The examined 3rd class carbon is from entry1 to 3 in Table 1. What can synthesizes S-derivatization thiourea was only entry1 in these three. The examined MPM group and the structure according to it are from entry5 to entry7 In table 1. What can synthesizes S-derivatization thiourea was entry5 and entry7 in these three. Entry1, 4, 5, 7, and 8 were made the examination material of the following reaction. The result of S-derivatization DTB synthesis of the second reaction is shown in Table 2. It was entry1 of Table 2, 2, and 3 that the reaction advanced. Although the generation rate of entry1 was low compared with 2 and 3, since the reaction advanced, examination of the last reaction was also performed. The result of elimination reaction of S-inducement part of the last reaction is shown in Table 3. It was entry1 of Table 3, and 3 that the reaction advanced. Since entry1 had the strong bad smell, it became clear that it was not suitable for practical use. In entry3, it R group disconnects by adjusting the acidic condition of a reactive solution, and It was checked that an object is obtained at a rate of about 100% by TLC check. The product in Table 3 which disconnected R group and was carried out the separation refinement by column chromatography. NMR measurement of this obtained compound, elementary analysis, and IR measurement were performed, it was confirmed that diPhDTB that was the final objective was certainly synthesized. The result of the C-13 NMR spectrum is shown in the figure in conjunction with identification of the chemical structure.

### Comparative Example 2

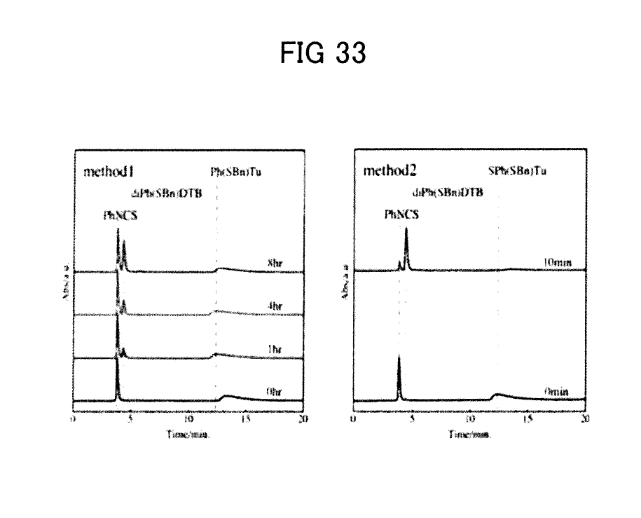

It explains comparison between solution synthesis and non-solvent synthesis (monomers) referring to FIG. 33. In order to compare solution synthesis with non-solvent synthesis, the reaction time and the yield of the model monomer were compared. As for the polymer reaction, as for the reaction of the model monomer, the basic reaction is the same. The polyaddition reaction of the amine of CNS and S-benzyl-thiourea is a basic unit of the reaction. Because the speed of the polyaddition reaction of this basic unit is slow, the synthesis and reactive time becomes long. In comparative experiments, promotion of the basic unit of a reaction was considered using the model monomer which is a simpler system.

### 2-1) Sample and Synthesis Method

The examined samples used the commercial item for synthesis as it was. The confirmation of the reaction was evaluated by the TLC check. After narrowing an effective condition in the HPLC evaluation, A quantitative reactive pursuit was performed by HPLC evaluation. Next, the synthesis method of diPh(SBN)Tu used to examine the reactive promotion method is described.

### 2-2) Synthesis of DiPh(SBN)Tu

1-pheneylen-2-thiourea of 0.15 g (1 mmol) and benzoylchloride of 0.19 g (1.5 mmol) were added to ethanol 2 ml. The heating at reflux was done while stirring this solution. The heating stir was continued for about two hours, and the reaction was ended. About 20 ml of hexane was added to reaction solution, the object was extracted, and the furnace exception carried out. Ph(SBn)Tu source hydrochloride 0.195 g (0.7 mmol) was obtained by washing, and drying.

### 2-3) DiPh(SBn)DTB Synthesis(Solvent Synthesis Method1)

Ph(SBn)Tu source hydrochloride 0.28 g (1 mmol) was putted into the mixture solution of Sodium hydrogencarbonate saturated water solution/THF/ether=25 ml/25 ml/25 ml, it stirred at the room temperature, and the desalination processing was done. Ph(SBn)Tu that did the desalination processing was obtained by extracting this solution, dehydrating, and doing the decompression dryness. The departure medicine was dissolved to THF 8 ml after this S-derivatization thiourea and phenyl isothiocyanate of 0.135 g (1 mmol) were added to the recovery flask, and the heating reaction was done for 8 hours at 70° C. After it had reacted, DiPh(SBn)DTB of the objective was obtained by column chromatography.

### 2-4) DiPh(SBn)DTB Synthesis (Non-Solvent Synthesis Method2)

Ph(SBn)Tu source hydrochloride 0.28 g (1 mmol) was putted into the mixture solution of Sodium hydrogencarbonate saturated water solution/THF/ether=25 ml/25 ml/25 ml, it stirred at the room temperature, and the desalination processing was done. Ph (SBn) Tu that did the desalination processing was obtained by extracting this solution, dehydrating, and doing the decompression dryness. After this S-derivatization thiourea and phenyl isothiocyanate 0.135 g (1 mmol) were added to the recovery flask, after dissolving a start agent in THF once, carrying out decompression drying of it, removing THF and changing into a slurry state, the heating reaction was done for 10 minutes at 70° C. After it had reacted, DiPh(SBn)DTB of the objective was obtained by column chromatography.

### 2-5) Experimental Result

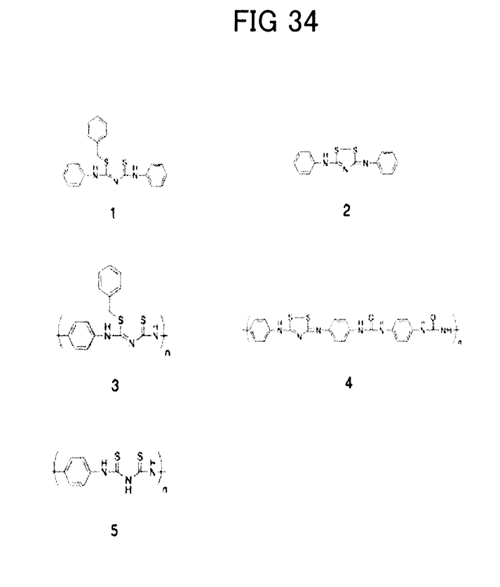

The spot of the departure medicine would disappear in 10 minutes, and it became only the spot of a target product in the non-solvent synthesis of method2 as a result of doing a reactive confirmation by TLC. On the other hand, the spot of the departure medicine did not disappear in the non-solvent synthesis of method1 8 hours also after a reactive end. To do a more quantitative confirmation, it evaluated it by the HPLC chromatography though the effect of a reactive promotion was able to be confirmed by the evaluation by TLC. The HPLC chromatogram measurement was done by condition shown next, Column: Si60 (Kanto chemistry, Si60 250 mm×4.6), Eluate: ethyl acetate/hexane=1/1, Flow velocity: 1 ml/min, Detector: UV 250 nm, Sample amount: 20 μl. FIG. 33 shows the chromatogram of the result of a measurement. Graph method1 on the left of FIG. 33 shows the result of the current synthetic method, and right graph method2 shows the result of a non-solvent reaction. PhNCS and Ph(SBN)Tu show the departure material in figure, and diPh(SBn)DTB shows a target product. The retention time becomes the order of PhNCS, diPh(SBn)DTB, and Ph(SBN)Tu. Even if 8 hour had passed since the reaction start, the peak of PhNCS and diPh(SBn)DTB was almost the same. If the molar ratio is converted from the absorption constant of PhNCS and diPh(SBn)DTB in the detection wavelength of 255 nm, it becomes about 1:3, It was able to be confirmed that 70 percent or more was reactive in 8 hours by the reaction of method1. On the other hand, in method2 of FIG. 34, 10 minutes after the reaction start, the peak of PhNCS and Ph(SBN)Tu disappeared mostly, and it became only a peak of diPh(SBn)DTB.

### Comparative Example 3

The Solution synthesis and microwave synthesis (monomers) are compared.

In order to compare solution synthesis with non-solvent synthesis, the reaction time and the yield of the model monomer were compared. As for the polymer reaction, as for the reaction of the model monomer, the basic reaction is the same. The polyaddition reaction of the amine of CNS and S-benzyl-thiourea is a basic unit of the reaction. Because the speed of the polyaddition reaction of this basic unit is slow, the synthesis and reactive time becomes long. In comparative experiments, promotion of the basic unit of a reaction was considered using the model monomer which is a simpler system.

### 3-1) Sample and Synthesis Method

The examined samples used the commercial item for synthesis as it was. The confirmation of the reaction was evaluated by the TLC check. After narrowing an effective condition in the HPLC evaluation, A quantitative reactive pursuit was performed by HPLC evaluation. Next, the synthesis method of diPh(SBN)DTB used to examine the reactive promotion method is described.

### 3-2) Synthesis of DiPh(SBN)Tu

1-pheneylen-2-thiourea of 0.15 g (1 mmol) and benzoylchloride of 0.19 g (1.5 mmol) were added to ethanol of 2 ml. The heating at reflux was done while stirring this solution. The heating stir was continued for about two hours, and the reaction was ended. About 20 ml of hexane was added to reaction solution, the object was extracted. A reactive thing was dried after the washing operation of the sludge was repeated several times, and Ph(SBn)Tu source hydrochloride of 0.195 g (0.7 mmol) was obtained.

### 3-3) DiPh(SBn)DTB Synthesis (Solvent Synthesis Method1)

Ph(SBn)Tu source hydrochloride 0.28 g (1 mmol) was putted into the mixture solution of Sodium hydrogencarbonate saturated water solution/THF/ether=25 ml/25 ml/25 ml, it stirred at the room temperature, and the desalination processing was done. Ph(SBn)Tu that did the desalination processing was obtained by extracting this solution, dehydrating, and doing the decompression dryness. The departure medicine was dissolved to THF 8 ml after this S-derivatization thiourea and phenyl isothiocyanate 0.135 g (1 mmol) were added to the recovery flask, and the heating reaction was done for 8 hours at 70° C. After it had reacted, DiPh(SBn)DTB of the objective was obtained by column chromatography.

### 3-4) DiPh(SBn)DTB Synthesis (Microwave Synthesis)

Ph(SBn)Tu source hydrochloride 0.28 g (1 mmol) was putted into the mixture solution of Sodium hydrogencarbonate saturated water solution/THF/ether=25 ml/25 ml/25 ml, it stirred at the room temperature, and the desalination processing was done. Ph(SBn)Tu that did the desalination processing was obtained by extracting this solution, dehydrating, and doing the decompression dryness. The microwave reaction was done by using Discover made by the SEM company. The glass tube (10-ml sealing vial with exclusive septum) for Discover also in a glass container was used. After this S-derivatization thiourea and phenyl isothiocyanate 0.135 g (1 mmol) were added to the glass tube, after dissolving a start agent in THF once, carrying out decompression drying of it, removing THF and changing into a slurry state, It sealed it with the silicon septum lid. This sealing up vial was set up in Discover made by the SEM company by a predetermined method, the microwave reaction was executed while performing magnet stir at 70° C. in preset temperature and 10 minutes in reactive time. After the reaction ends, A reactive thing in the glass tube is dissolved by THF once, DiPh(SBn) DTB that was the objective was obtained by the column chromatography of the solution.

### 3-5) Experimental Result

As a result of performing the reaction check by TLC, In the solvent synthesis of method1, while the spot of the departure thing did not disappear 8 hours after a reactive end, in the microwave synthesis of method2, the spot of the departure medicine disappeared almost after the reaction, and it was confirmed that most was a spot of a target product.

### Comparative Example 4

### Lithium Battery Reaction

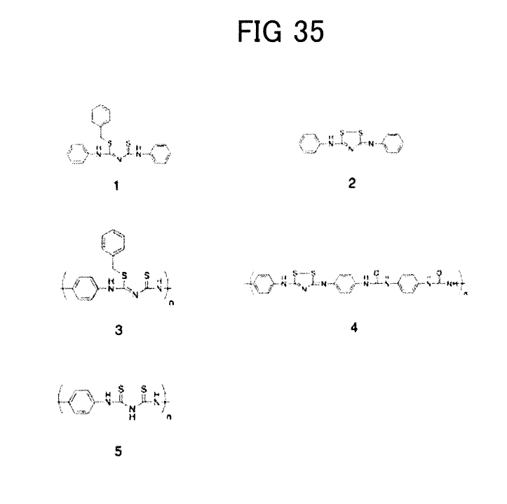

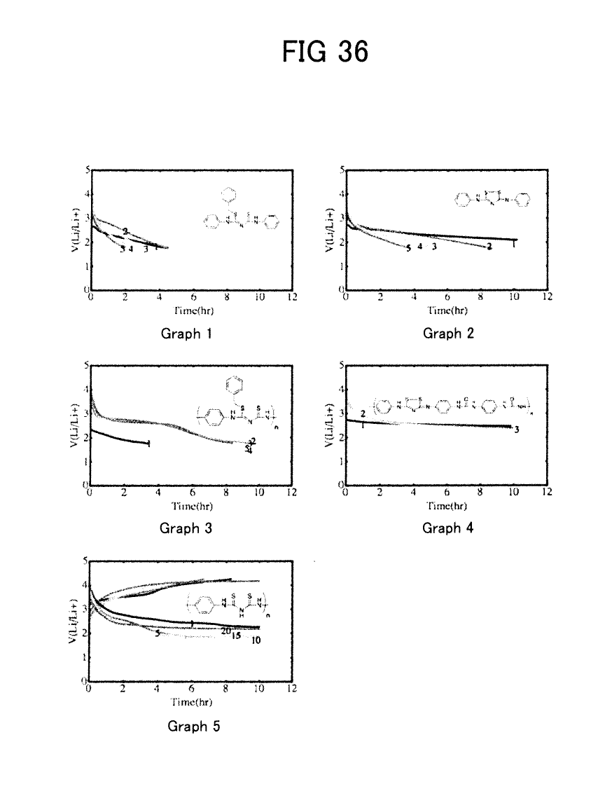

As shown in FIG. 35 and FIG. 36, the compound shown in 5 from 1 adjusted with the synthetic method described in the embodiment is chosen as an anode active material, the lithium battery was made by the following methods, and the battery characteristic was evaluated. The capacity of the anode active material was assumed the completion when discharge and charge reaction was made to react about two electrons per two atom of sulfur for each unit and led.

### 1) Creation of an Anode Element

Lithium battery anode medical mixture powder of 1 g was adjusted by carrying out pulverization mixture of anode active material, acetylene black, and the PVDF on a mortar by bulk density 45/45/10. NMP was suitably added to this powder as a dilution solvent, and the anode mixture ink to applying was adjusted. The addition of NMP ended when the anode mixture ink became like the slurry. The anode mixture ink like the slurry was applied to the aluminum foil of 20 μm in thickness with the coater braid. After carrying out preliminary drying under room temperature for after-application 24 hours, 60° C., and 5-hour dry processing were performed with the vacuum dryer, and the anode sheet was created. After carrying out 70° C., heat press processing after dryness, it is pierced by the circle of 10φ, the anode element was created. After performing 60° C. and 2-hour drying by heating processing to this anode element with a vacuum dryer again, it was quickly moved to the glove box and the lithium battery was created continuously.

### 2) Creation of a Lithium Battery

The glove box is carrying out the flow of the dry air of 70° C. of dew point, the lithium battery was assembled under this dry atmosphere. The anode element created by 3-1 is used for an anode, and 1M-LiPF6-EC-DMC was used for the electrolyte solution. The metallic lithium pierced by 12φ is used for a negative pole, and the cell guard pierced by 14φ was used for the separator. The coin type cell of 2032 types is prepared as an exterior material of the battery, and it occupies it with an exclusive rivet machine that set it up in the glove box after assembling the material, and the coin type cell for the examination was made.

### 3) Battery Evaluation

The lithium battery created by 2) was measured by the constant current reaction of ten hour rates, the lower bound voltage 1.74V and upper bound voltage 4.25V when electricity is discharged, Quiescent-period 15 minutes at the time of the change of charge and electric discharge, and the battery reaction temperature is the room temperature under. The result is shown from FIG. 1 in FIG. 5. The number of the curve in an individual graph shows the frequency of the electrical discharge. Graph 1 of FIG. 36 shows the electrical discharge result of sample 1, 2 of FIG. 36 is a discharging curve which shows the result of battery reaction measurement of the sample 2, 3 of FIG. 36 is a discharging curve which shows the result of battery reaction measurement of the sample 3, 4 of FIG. 36 is a discharging curve which shows the result of battery reaction measurement of the sample 4, and 5 of FIG. 36 is a discharging curve which shows the result of battery reaction measurement of the sample 5. The chemical formula of each sample is described clearly in figure. The samples adjusted with patent technology in this case are 3, 4, and 5, and 1 and 2 are comparison samples. By comparing the electric discharge graph of the low molecule monomer of the graphs 1 and 2, it turns out that protecting group removal is effective to a battery characteristic. The electrical discharge time is short in first time in case of the unremoval benzyl while the discharge reaction first time maintains 10 hours of necessary when the benzyl of the protecting group is removed beforehand. In the discharge reaction since the second times, since electric discharge time is longer to remove, it turns out that a capacity maintenance rate is good. By comparing the graphs 3, 4, and 5 shows that the effect of removal of a protecting group is effective also in polymer. Although the time of the electric discharge first time is short in the benzyl unremoval and electric discharge capacity is small, in the samples 3 and 4 which removed the protecting group, a necessary 10-hour reaction is attained from the 1st electric discharge. Furthermore, also in the battery reaction for the and afterwards time, it is clear from the form of a discharging curve that protecting group removal is effective. Although the middle to potential becomes less flat in 3 of benzyl unremoved, In 4 protecting group removed and 5, it turns out that the flatness of potential is maintained. It is desirable as the battery material from the viewpoint of samples' 4 and 5 being able to offer the equipment a constant voltage compared with material 3, and to maintain higher energy. Moreover, though the difference was not able to be shown by several-time discharge and charge reaction, it is needless to say that samples 4 and 5 to which it is impurities and the benzyl which causes battery side reactions, such as prevention, does not exist in the inside of a battery and whose electric discharge capacity of efficiency also improves are more desirable as the battery anode material. When converting it when two electrons of the origin of sulfur for each unit of the unit react, the capacity of sample 4 becomes mAh/g, although it is not high capacity so much, a various polymer can be obtained by performing a polymerization reaction combining a building block, and furthermore, it can be said that it has meaning of enough in the ability of it being material with high validity which carries out a battery reaction by two electron reactions of sulfur origin of the polymer to have been shown as an invention thing.

### Embodiment (9)

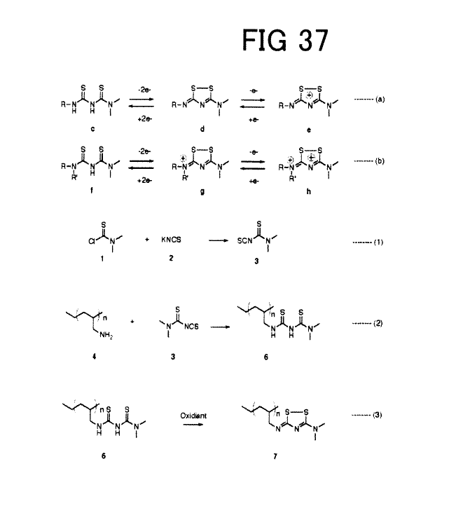

As shown in FIG. 37, the embodiment 9 is explanation of the synthetic method of the functional polymerization thing which has the dithiobiuret or the 1,2,4-dithiazole ring in a side chain and the embodiment 9 is explanation of the functional polymerization thing which has the dithiobiuret or the 1,2,4-dithiazole ring obtained newly by that cause in a side chain. In the embodiment of a past patent, The chemical compound of the polymerization thing which has the dithiobiuret or the 1,2,4-dithiazole ring is the precursor made S derivatization conductor, and there is only the statement that after building the functional polymer which has the dithiobiuret or the 1,2,4-dithiazole ring into an electrode element, it is obtained by electrolysis processing, it is obtained by electrolysis processing and the method by chemical synthesis was not specified. In this synthesis method, it becomes possible to obtain the functionality polymer which has the dithiobiuret or the 1,2,4-dithiazole ring by chemical synthesis, and there is no necessity for electrolysis processing. It is the method of making it possible for this synthetic method to introduce the dithiobiuret or the 1,2,4-dithiazole ring into polymerization concerned thing side chain by performing a chemical reaction as post-processing after forming the polymer which has an amino group in repetition structure, or the polymer which has an imino group in repetition structure, and to obtain new functional polymer. Dimethylhiocarbamoyl isothiocyanate is used as an introduction medicine of the dithiobiuret in this method. Since the dimethylhiocarbamoyl isothiocyanate has a big reactivity to amine, it reacts to the nitrogen part of a polymer efficiently and the dithiobiuret structure is formed, it becomes possible to introduce the dithiobiuret or the 1,2,4-dithiazole ring into the polymer which has an amino group in repetition structure, or the polymer which has an imino group in repetition structure efficiently. Moreover, since the reactivity of the dimethylhiocarbamoyl isothiocyanate is large, if the polymer has an amino group in repetition structure, it will become possible to existing or a new polymer to apply this synthetic method and to obtain the functional polymer of varieties newly. The oxidation-reduction reaction in the SS portion of the functional polymerization thing which has the dithiobiuret or the 1,2,4-dithiazole ring obtained in this way in a side chain becomes possible. Furthermore, since the 1,2,4-dithiazole ring can take the further oxidation state according to the effect of electronic granting stabilization of dimethyl of N title, it can become a big new material of the possibility of use as a high capacity battery material. An example of this method is shown as the embodiment below.

### 1) Synthesis of Dimethylhiocarbamoyl Isothiocyanate

The solution that added dimethyl thiocarbamoyl chloride of 4 mmol and thiocyanic acid potassium of 6 mmol to acetone 50 ml was heated at reflux for 15 minutes. After the cold of a reactive liquid was discharged at the room temperature, suction filtration was carried out and the filtrate was collected. In this way, the acetone solution in which dimethylhiocarbamoyl isothiocyanate of the object was dissolved was able to be obtained. Because dimethylhiocarbamoyl isothiocyanate can be synthesized by the yield about 100%, and the reactiveness of dimethylhiocarbamoyl isothiocyanate is large, it converted that the acetone solution which the object of 4 mmol dissolved was able to be obtained, and used it for the subsequent reaction as it was.

2) Synthesis of Polyallyl that has N-Dimethyl Dithiobiuret on Side Chain

The solution that dissolved dimethylhiocarbamoyl isothiocyanate to the acetone was made reactive solution A. Polyallylamine solution of 1 mmol (The amine one unit is converted as 1 mmol and the amount has been adjusted.) of 20% is dissolved to DMSO 20 ml and reactive solution B has been adjusted. After the reaction solution A is dropped over 5 minutes, while stirring reactive solution B in the room temperature, heating at reflux was performed at 80° C. for 1 hour. Afterwards, the reactive solution was poured into the ethanol, the sludge was washed with the ethanol and THF, the vacuum dried, and polyallyl of the objective that has N-dimethyl dithiobiuret on side chain was obtained by the yield 80%.

3) Synthesis of Polyallyl that has N-Dimethyl-1,2,4-Dithiazole Ring on Side Chain

Polyallyl of 1 mmol that had A on the side chain was crushed with the mortar in detail, the solution that distributed it to the mixture solution of the ethanol and THF was used as reactive solution A. Iodine 1 mmol of 20% is dissolved to ethanol 20 ml and reactive solution B has been adjusted. After the reaction solution A is dropped over 5 minutes, while stirring reactive solution B in the room temperature, heating at reflux was performed at 80° C. for 1 hour. Afterwards, the reactive solution was poured into the ethanol, the sludge was washed with the ethanol and THF, the vacuum dried. The solid obtained thus was crushed with the mortar, the stir was done in the mixture solution of water of NaHCO₃ and THF at the room temperature for 3 hours. Afterwards, the filtration thing was washed with the water and THF, the vacuum dried, and polyallyl of the objective that has N-dimethyl-1,2,4-dithiazole ring on side chain was obtained by the yield 75%.

### [Modifications]

Although the above-mentioned enforcement form explains the anode active material which has n dope domain and p dope domain in a molecule, for instance, the anode which compose a rechargeable battery may composed of the mixture material which had n dope material and p dope material mixed in the domain where the voltage of the battery can be used. The electrochemical order of n dope domain and p dope domain is important at this time. In a lithium system battery, the battery reaction mechanism by the side of an anode in case lithium moves between a anode-cathode is shown. At the time of charge, first, the reaction of p dope material (Escape p dope) occurs in the potential of the lower one, next, the reaction of n dope material (n dope) occurs in higher potential than a while ago. It reverses when electricity is discharged. An order that first, the reaction of n dope material (Escape n dope) occurs in the potential of the higher one, next, the reaction of p dope material (p dope) occurs in the potential of the lower one is required. It may be polymer connected with oxalaldehyde by copolymerization in N title of phenazine as other anode active material

### INDUSTRIAL AVAILABILITY

It is applicable to a rechargeable battery etc.

### EXPLANATION OF A SIGN

1 Chemical substance

What is claimed is:

1. A rechargeable battery comprising:
an anode which consisted of an anode material including n dope domain and p dope domain, and in which many electron reactions are possible; and
an electrolyte that a density of movable ion was adjusted to a density corresponding to the amount of substance of the anode material.

2. The rechargeable battery according to claim 1, wherein:
the anode material is a functional polymer which has a dithiobiuret or a 1,2,4-dithiazole ring in a side chain.

3. A functional polymer which has a dithiobiuret or a 1,2,4-dithiazole ring in a side chain.

4. Synthesis method of functionality polymerization thing comprising;
a protection process of adding a 4-methoxybenzyl chloride to a compound which has 1 or plural thiourea group in the same molecule, combining a 4-methoxybenzylic group with the thiourea group, and obtaining a MPM compound;
a Polymerization process to add an organic solvent to the obtained MPM compound, and to heat it to reflux, and to get an organic sulfur MPM polymer; and
a deprotection process to add an anisole in the obtained organic sulfur MPM polymer under an acid condition, and to heat it to reflux, and to get an organic sulfur polymer.
